(19) United States
(12) Patent Application Publication
(10) Pub. No.: US 2016/0051957 A1
(43) Pub. Date: Feb. 25, 2016

(54) Energy-Producing Reaction Devices, Systems and Related Methods

(71) Applicant: Industrial Heat, LLC, Raleigh, NC (US)

(72) Inventors: Andrea Rossi, Miami Beach, FL (US); Thomas Barker Dameron, Raleigh, NC (US)

(21) Appl. No.: 14/627,828

(22) Filed: Feb. 20, 2015

Related U.S. Application Data
(60) Provisional application No. 61/943,016, filed on Feb. 21, 2014.
(60) Provisional application No. 62/060,215, filed on Oct. 6, 2014.

(51) Int. Cl. B01J 19/00

(52) U.S. Cl. CPC B01J 19/0013; B01J 2219/00063

(57) ABSTRACT

A reactor device includes a reaction chamber; one or more thermal units in thermal communication with the reaction chamber configured to transfer thermal energy to the reaction chamber; and a refractory layer between the reaction chamber and the one or more thermal units.

### RELATED APPLICATIONS

This application claims priority to U.S. Provisional Application Ser. No. 61/943,016, filed Feb. 21, 2014, and U.S. Provisional Application Ser. No. 62/060,215, filed Oct. 6, 2014, the disclosures of which are hereby incorporated by reference in their entireties.

### FIELD OF THE INVENTION

The present invention relates to an energy-producing reaction device.

### BACKGROUND

The use of fossil fuels present many problems including environmental pollution related to both fossil fuel use and extraction from the environment. The easily accessible sources of fossil fuels are also decreasing, which encourages new techniques for extracting fossil fuels from the ground that are both costly and have the potential to harm the environment, such as hydraulic fracturing and deep water oil drilling.

Although other alternative and renewable energy sources, such as hydropower, wind, and solar energy, have helped reduce the need for fossil fuels, there remains a need to reduce or replace the use of fossil fuels with cheaper and more environmentally friendly alternative energy sources along with a need for systems and devices for generating energy from such fuels.

### SUMMARY

In some embodiments, a reactor device includes a reaction chamber; one or more thermal units in thermal communication with the reaction chamber configured to transfer thermal energy to the reaction chamber; and a refractory layer between the reaction chamber and the one or more thermal units.

The refractory layer may include at least one recess configured to receive the one or more thermal units therein. The one or more thermal units may include one or more resistive wires. The at least one recess may include a spiral groove and the one or more resistive wires may be helically-disposed in the groove. The one or more resistive wires may include at least three wires carrying a three-phase alternating-current electric power. The refractory layer may include a ribbed or finned surface that increases heat dissipation away from the reaction chamber.

In some embodiments, sealing members seal the reaction chamber.

In some embodiments, the reaction chamber is open such that it does not maintain a pressurized seal.

In some embodiments, the reaction chamber comprises a longitudinally extending cylinder.

In some embodiments, a reactor system includes a reactor device comprising: a reaction chamber; one or more thermal units in thermal communication with the reaction chamber configured to transfer thermal energy to the reaction chamber; a refractory layer between the reaction chamber and the one or more thermal units. The system further includes a controller configured to control a thermal output of the one or more thermal units.

In some embodiments, a temperature sensor is configured to sense a temperature of at least a portion of the reaction chamber. The controller may be configured to control the thermal output of the one or more thermal units responsive to a temperature sensed by the temperature sensor.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a perspective view of an energy-producing reactor according to some embodiments.

FIG. 2 is an exploded view of the reactor of FIG. 1.

FIG. 3 is a perspective view of an energy-producing reactor according to some embodiments.

FIG. 4 is an exploded view of the reactor of FIG. 3.

FIG. 5 is a cut away side view of an energy-producing reactor according to some embodiments.

FIG. 6 is an exploded view of the reactor of FIG. 5.

FIG. 7 shows a reactor device according to at least one embodiment.

FIG. 8 shows the device of FIG. 7, installed on a metal frame according to at least one embodiment.

FIG. 9 shows an exemplary setup for the measurements including a reactor control system, two PCEs for electric power measurements, and a multimeter.

FIG. 10 shows a wiring diagram according to at least one embodiment, in which two PCEs are located one upstream and one downstream from control instruments.

FIG. 11 shows the checking of the system's input voltages and currents according to at least one embodiment.

FIG. 12 shows that all the waveshape harmonics input to the system were within the PCE's measuring range.

FIG. 13A is a prior art discrete point plot of the emissivity of said material as a function of temperature.

FIG. 13B is a continuous line trend of alumina emissivity as a function of temperature, reproduced from data extracted from the plot in FIG. 13A.

FIG. 14A is a thermography image of rods to the right of the device of FIG. 7.

FIG. 14B shows thermal conductivity k (W/mK) of air as a function of temperature.

FIG. 14C shows thermal diffusivity α (m²/s) of air as a function of temperature.

FIG. 14D shows kinematic viscosity ν (m²/s) of air as a function of temperature.

FIG. 15 is a representation of a circular fin having a triangular profile; its shape is very similar to that of the reactor ridges and was used as a model to calculate natural convection.

FIG. 16 is a plot showing the efficiency of a circular fin having triangular profile.

FIG. 17A shows an image taken from the dummy's thermography file, processed for data analysis.

FIG. 17B is a thermography image of the set of three rods on the left of the reactor.

FIG. 18A shows average temperatures of area of the device of FIG. 7 at the time of power supply increase.

FIG. 18B shows a net power production trend for the device of FIG. 7 with each interval on the x-axis representing a time span of about two days.

FIG. 18C shows mean power consumption of the device of FIG. 7 with each interval on the x-axis representing a time span of about two days.

FIG. 18D shows a COP trend for the device of FIG. 7 with each interval on the x-axis representing a time span of about two days.

FIG. 19A is an image of the device of FIG. 7 operating, showing resistors exiting the caps and entering the rods, their high temperature due to heat extracted from the reactor by conduction.

FIG. 19B is an image of the device of FIG. 7 operating, taken in the dark, from the opposite side to that of FIG. 19A.

FIG. 20 is a “Ragone plot of energy storage” of the prior art that shows specific gravimetric energy and power densities relevant to various sources.

FIG. 21 is another prior art Ragone plot of energy storage showing specific volumetric and gravimetric energy densities given for various sources.

FIG. 22 shows a slide with fragments attached, the fragments being a sample of material taken from one of the fins of the device reactor of FIG. 7 for analysis.

FIG. 23 shows a spectrum collected of the slide sample shown in FIG. 22.

FIG. 24 shows other peaks found compared to the two primary materials found in the sample of FIG. 22.

FIG. 25 is a schematic diagram of the relative position of the detector with respect to the device.

FIGS. 26A-26C are scanning electron microscopy (SEM) images of three different particles in the fuel material.

FIGS. 27A-27B are SEM/SEI images of two different particles in the ash material.

FIG. 28A is an SEM/SEI image of the areas where energy dispersive x-ray spectroscopy (EDS) analysis were performed on the different fuel particles.

FIGS. 28B-28D are graphs of EDS spectra for the three particles shown in FIGS. 26A-26C.

FIG. 29A is an SEM/SEI image showing the areas were EDS analysis were performed on the different ash particles.

FIGS. 29B-29C are graphs of EDS spectra for the two particles shown in FIGS. 27A-27B.

FIGS. 30A-30B are graphs of the positive time of flight/SIMS spectrum of a carbon adhesive sticker surface for 0-100 amu (FIG. 30A) and 100-300 amu (FIG. 30B).

FIGS. 31A-31B are graphs of the positive time of flight/SIMS spectrum of the surface of a fuel powder grain before sputter cleaning for 0-100 amu (FIG. 31A) and 100-300 amu (FIG. 31B).

FIGS. 32A-33B are graphs of the positive time of flight/SIMS spectrum of the surface of a fuel powder grain after sputter cleaning for 180 s for 0-100 amu (FIG. 32A) and 100-300 amu (FIG. 32B).

FIGS. 33A-33B are graphs of the positive time of flight/SIMS spectrum of the surface of a fuel powder grain after sputter cleaning for 180 s followed by storing 16 hours in the vacuum chamber for 0-100 amu (FIG. 33A) and 100-300 amu (FIG. 33B).

FIGS. 34A-34B are graphs of the positive time of flight/SIMS spectrum of the surface of the fuel (FIG. 34A) and ash (FIG. 34B) powder grain after sputter cleaning for 180 s.

FIGS. 35A-35B are graphs of the positive time of flight/SIMS spectrum of the surface of different fuel powder grain after sputter cleaning for 180 s for a fuel powder grain with low Ni content (FIG. 35A) and a fuel powder gain having high Fe content (FIG. 35B).

FIGS. 36A-36B are graphs of the positive time of flight/SIMS spectrum of the surface of different fuel powder grain after sputter cleaning for 180 s for a fuel powder grain with Li content (FIG. 36A) and a fuel powder gain without Li (FIG. 36B).

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

Embodiments according to the present invention relate to energy-producing reaction devices. In particular, a reaction device according to some embodiments includes a reaction chamber that is formed of at least one thermally conductive wall. The reaction chamber may include a reactive material that is configured to produce energy under certain conditions. A thermal unit is placed in thermal communication with the thermally conductive wall so that, when the thermal unit is heated or cooled, the thermal energy is transferred to at least a portion of the reactive material in the reaction chamber.

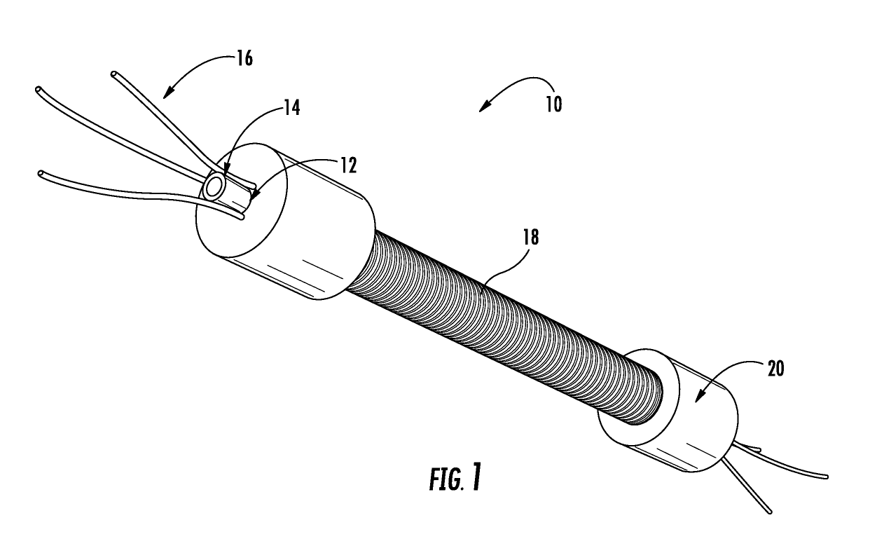

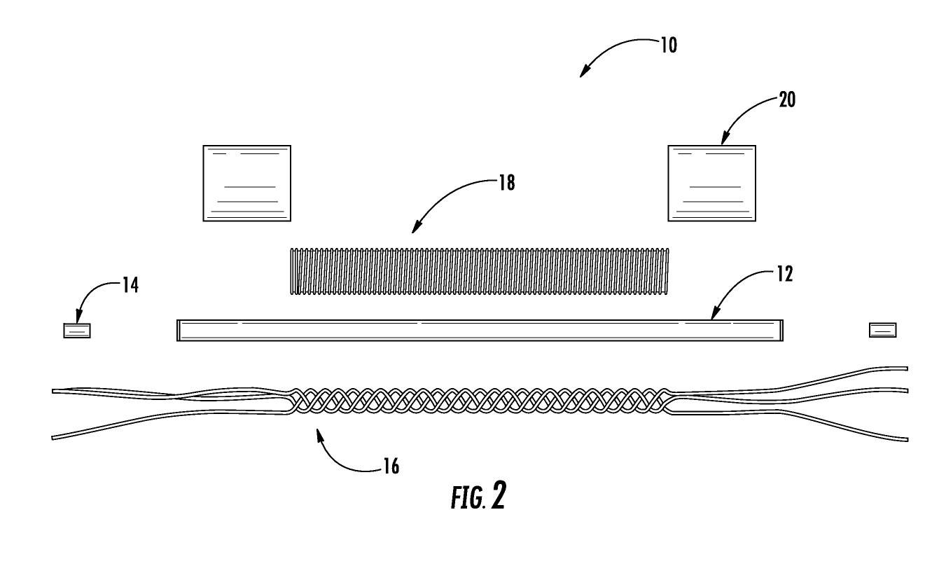

As illustrated in FIGS. 1 and 2, in some embodiments, a reaction device 10 includes a reaction chamber 12 that forms a hollow cylinder and has sealing members 14 at opposing ends thereof. Although the reaction chamber 12 is illustrated as a cylinder, the reaction chamber may have other shapes in other embodiments which may have cross-section which may be a regular polygon and/or any closed geometric shape. The chamber may be uniform throughout its length (e.g. the cylinder) or may include one or more portions that vary in shape from another portion. The device 10 includes one or more thermal units or resistance wires 16 that are formed around the reaction chamber 12 and are configured to transfer heat to the reaction chamber 12. An additional refractory layer 18 and supports 20 are positioned around the resistance wires 16. In some embodiments, the wires 16 may be used to transfer thermal and/or electromagnetic energy to the reaction chamber 12. In some embodiments the device may be thermally coupled to one or more thermal units that are physically external to the device and that may be physically in contact with the device or not.

In this configuration, the reaction chamber 12 is configured to receive and contain an energy-producing reactive material, referred to herein as a “fuel” or “charge”, therein. When electric power is driven through the resistance wires 16, heat and/or electromagnetic radiation is provided to the reaction chamber 12 to thereby drive the reaction of the reactive material in the chamber 12. A reaction may be controlled by varying the current, voltage, and/or waveform of the electrical signal driven through the resistance wires 16. Without wishing to be bound by any particular theory, the reactive material in the chamber 12 produces products and energy from a chemical and/or a nuclear reaction, such as thermal energy and/or electromagnetic radiation, in response to the energy input from the electrical power provided through the resistance wires 16. The energy input from the resistance wires 16 may include heat (e.g. conducted, inducted, and/or radiated) and/or electromagnetic radiation.

The reaction chamber 12 may be formed of any suitable thermally conductive material, such as ceramic and/or a metal. In particular embodiments, a high-alumina ceramic is used. The ceramic may be generally non-porous and able to withstand very high temperatures. In some embodiments, a suitable a high-alumina ceramic has a nominal density of 0.14 lbs/cu. in., a modulus of elasticity of 0.054 ksiX10̂6, a tensile strength of 31,000-36,000 psi, a flexural strength of 54,000-58,000, thermal conductivity @ 212 deg F. of 180-209 BTU-in/hr-sq. ft, a coefficient of thermal expansion of 46 10̂7/deg F., and refraction index of 1.76-1.79. Those skilled in the art will understand based on upon the present disclosure that the attributes of a thermally conductive material included in a reaction device may vary based upon a reactive material, a target energy output and/or maximum energy output, a target energy input and/or a maxim energy input, a use of the reactor device, a pattern of energy input and/or output, and/or a location of the device with respect to another object and/or person—to name some examples. Alternatively or additionally, thermally conductive material may thermally couple at least a portion of the reactor chamber to an area external to the reactor device. The reaction chamber 12 may be formed and/or may otherwise include a metal, such as stainless steel. For example, stainless steel 306, 310, and 316 are each suitable. Those skilled in the art will understand based on upon the present disclosure that the attributes of a reaction chamber such as a material that it includes may vary based upon a reactive material, a target energy output and/or maximum energy output, a target energy input and/or a maxim energy input, a use of the reactor device, a pattern of energy input and/or output, and/or a location of the device with respect to another object and/or person—to name some examples. When stainless steel or other electrically conductive material is included, resistance wires 16 may be separated from the electrically conductive material to prevent arcing or other forms of electrical interference. For example, a ceramic material may be included between the electrically conductive material of the chamber 12 and resistance wires 16. In some embodiments, a temperature sensor, such as a thermocouple (not shown), is positioned in or adjacent to the reaction chamber 12 and may be used to monitor and control the thermal output from the reaction chamber 12. Other sensors may be included for monitoring and controlling the thermal output, such as an infrared camera, a Geiger counter, a resistance temperature detector (RTD), a heat gun and/or a neutron detector or other particle detector. In particular embodiments, one or more temperature sensors may be connected to a computer or controller, for example, as feedback to logic that when executed by a processor controls the current through the resistance wires 16 so that the power is turned off, reduced and/or the electrical waveform is modified when, for example, a sensor (e.g. a temperature sensor) indicates that energy input (as indicated by the temperature), is above a predetermined upper threshold. Optionally, the power may be turned on, increased, and/or the waveform modified when, for example, a sensor indicates that energy input is below a lower threshold. Further, a sensor may indicate that energy output is above an upper threshold amount. In response, a logic circuit or software module may operate to reduce and/or cutoff energy input or to otherwise cool the device. Further, a sensor may indicate that energy output is below a lower threshold amount, which may trigger additional power to be generated to increase the temperature. Oscillating temperatures (i.e., heating and cooling) may also be used. In response, a logic circuit may operate to increase and/or or turn on energy input or to otherwise direct energy to the reactor chamber. A threshold may be predetermined based on one or more of the reaction chamber 12, the refractory 18, an application or use of the reactor, a user specified setting, a time of operation, a pattern of energy input and/or output, a contract, a geospatial location of the reactor, a second reactor, a user of the reactor, and/or the particular reactive material—to name some examples. For example, a reaction chamber 12 formed from ceramic may conduct heat and/or transfer electromagnetic energy to the reactive material more or less efficiently than a reaction chamber formed of stainless steel. Similarly, the upper threshold temperature may be based on one or more attributes of the wires 12. For example, the spacing of the wires may cause outside temperature measurements to differ for a desired internal temperature measurement. Still further, the upper threshold temperature may be based on the type(s) and placement of one or more sensors (described above). A device may be used to produce energy for various uses. The upper threshold temperature may be determined based on a particular use. The current may be increased or turned on when a temperature sensor indicates that the temperature is below a predetermined lower threshold amount. A predetermined lower threshold may be based on any one or more of the attributes just described with respect to the upper threshold. In some embodiments, the lower and upper thresholds may be in a range of 250-1200° C., but as stated temperature thresholds may vary in other embodiments. Accordingly, the wires 12 are configured to add heat and/or electromagnetic radiation to the reactor 10 to produce energy in the reaction chamber 12.

Outputs of other sensors and/or other detectable attributes of any of the various components of a reactor, a reactive material, and/or a reaction may be monitored, as described. One or more criterion may be specified based on any one or more of the outputs and/or other detectable attributes. A control system may be configured with logic to determine when a criterion is met. In response to determining that the criterion is met, logic may operate to identify an operation to perform. For example, logic may look up a record stored in a computer readable storage medium that identifies the criterion and identifies the operation. A control system may include and/or may otherwise interoperate with an output device to present output to instruct a user to perform some or all of the operation associated with a criterion. Alternatively, or additionally a control system may be communicatively coupled and/or operatively coupled to a source of a sensed input, such as thermal energy input to the reactor and/or to any other accessible attribute of the reactor, the reaction, and/or an environment of the reactor. The control system, in an embodiment, may include logic that operates to change the operation of an energy input source via the communicative coupling. In an option, a control system may communicate with a sensor and/or any other portion of a reactor system to change the operation of the sensor and/or the other portion. For example, a setting for a thermal imaging device may be modified as an attribute of the reactor changes as a result of operation (e.g. emissivity of a portion of a reactor system may change during operation of the reactor).

Although the sealing members 14 may provide an air-tight seal, in some embodiments, the sealing members 14 are sufficient to retain the reactive material, but do not necessarily maintain an air-tight seal. An air-tight seal may be used when the reactive material includes the addition of a gas, such as pressurized hydrogen; however, in some embodiments, the reactive material does not require a pressurized gas, and an air-tight seal is not necessary. For example, nickel hydride may be used as the reactive material with or without a pressurized gas. In particular embodiments, the reactive material is not sealed and may even be in contact or in fluid communication with the outside environment. An unsealed device may be easier to manufacture, transport, and maintain. Moreover, reactive materials that do not include pressurized hydrogen may be safer to use than those that utilize pressurized hydrogen. One or more criterion configured for a control system may be modified based on the reactive material. In an embodiment, a control system may determine and control sealing based on information identifying the reactive material. Sealing of a reactor may be altered during operation based on input form a sensor, a timer, and/or any attribute accessible to a control system.

As shown in FIG. 1, three helically-disposed resistance wires 16 are used. In some embodiments, the three wires 16 may carry three-phase alternating-current electric power. However, it should be understood that any suitable number of wires 16 and any suitable electric power and/or thermal power may be used. Electric power may be input at various frequencies and may have various waveforms. In some embodiments, single wires or a plurality of wires may be either spirally wound or linearly positioned adjacent the reaction chamber 12. In some embodiments, the reaction chamber 12 may have one or more guides, such as provided by a grooved surface, in order to receive the wires 16 therein. Positioning the wires 16 on a grooved surface may reduce a risk of or prevent the wires 16 from touching or arcing, thus reducing failures.

In some embodiments, an optional refractory layer 18 with supports 20 are positioned around the resistance wires 16 to thereby hold the wires in position. As illustrated, the refractory layer 18 has a ribbed or finned surface, which may increase heat dissipation away from the reaction chamber 12. It should be understood, however, that the refractory layer 18 may omit the ribbed or finned surface, and may instead have a smooth, rough or other surface configuration. The refractory layer 18 and supports 20 may be omitted in some embodiments. The refractory layer 18 may be formed of a thermally conductive material and may be electrically resistant to reduce or prevent shorting or arcing events. In some embodiments, the refractory layer 18, supports 20 and sealing members 14 are formed of an alumina base. For example, an alumina base with volume resistivity of 10″ ohm-cm or better, dielectric strength of 270 volts/mil or better, thermal expansion of 4.5 10^{-6/}defF or lower, and thermal conductivity of 15 BTU-in/defF-Hr-ft² or higher, such as Durapot™ 810 (Cotronics Corp., Brooklyn, N.Y. (USA)), is suitable. Those skilled in the art will understand based on upon the present disclosure that the attributes of a refractory layer may vary based upon a type of energy input, a reactive material, a positioning and/or coupling of an energy input unit with respect to a reaction chamber, a target energy output and/or maximum energy output, a target energy input and/or a maxim energy input, a use of the reactor device, a pattern of energy input and/or output, and/or a location of the device with respect to another object and/or person—to name some examples.

In some embodiments, each of the resistance wires 16 as shown may include two or more wires that are spirally wound together and optionally annealed to facilitate the spirally wound configuration shown in FIGS. 1 and 2. In some embodiments, the electrical current is carried to the resistance wires 16 using a resistance wire, such as copper, so that the wires 16 produce a larger amount of heat adjacent the chamber 12. In particular embodiments, the wires 16 are 2 guage 15 KA resistance wires, and prior to wrapping the wires 16 around the reactor chamber 12, an electrical current is passed through the wires 16 to reduce shape-memory characteristics. The resistance wire 16 converts electricity to heat by resisting the flow of electrons. The resistance wires 16 may optionally be annealed. For example, a 15 gauge wire with resistance of 2.650 ohms/ft is one example of suitable wire. As with other components of a reactor device 10, attributes of resistance wires 12 or other components of an energy input unit included in and/or otherwise providing energy to the reactive material may vary, and may include devices for heating and/or cooling the device 10 and/or providing electromagnetic radiation to the chamber 12.

Although the reaction chamber 12 is illustrated as a cylindrical chamber, any suitable size or shape chamber may be used. The reaction chamber 12 may be formed of any thermally conductive material that permits thermal energy transfer to and from the reactive material in the chamber 12. Alternatively or additionally, the reaction chamber may be include a thermally conductive material, which may in an embodiment extend through the reactor device to protrude from the outside of reaction chamber to transfer heat to or from the reaction chamber. The reaction chamber may be thermally insulating with respect to the thermally conductive material coupling the inside and outside of the reaction chamber. Such an arrangement allows energy output to be targeted, focused, and/or otherwise directed. Attributes of such protuberances may vary by use of a reactor device. Such attributes may include a material included in a protuberance, a distance that a protuberance extends into and out of a reactor device, a shape of protuberance, and the like.

Any suitable reactive material that produces energy (e.g. chemical, thermal, electromagnetic, and/or nuclear) in response to the thermal and/or electromagnetic input from the resistance wires 16 and/or other source of input energy may be used. Exemplary reactive materials are discussed in U.S. Patent Publication No. 2011/0005506 to Rossi, U.S. Patent Publication No. 2013/0243143 to Mastromatteo, U.S. Patent Publication No. 20110255645 to Zawodyny and U.S. Pat. No. 8,485,791 to Cravens, the disclosures of which are hereby incorporated by reference in its entirety. Additional reactive materials are discussed in European Patent Publication No. 2,368,252B1 to Piantelli; International Application No. PCT/FI2012/051171 to Soininen; Campari et al., “Ni—H Systems,” ICCF8 Conference Proceedings Vol. 70 (2000); Celani et al., “Improved understanding of self-sustained, sub-micrometric multi-composition surface Constantan wires interaction with H₂ at high temperatures: experimental evidence of anomalous heat effects,” Chemistry and Materials research, vol. 3, no. 12 (2013), and Final Report, Termacore, Inc., Contract No. F33615-93-C-2326, “Nascent Hydrogen: An Energy Source.” Exemplary reactive materials may include a metallic material able to absorb hydrogen (and its isotopes) in a sufficiently high amount for the triggering of nuclear reactions under predetermined operative conditions. Suitable metallic materials belong to the group of the transition metals and may be chosen from the group including: Sc, Ti, V, Cr, Mn, Fe, Co, Ni, Zn, Y, Zr, Nb, Mo, Tc, Ru, Rh, Ag, Cd, Lu, Hf, Ta, W, Re, Os, Ir, Pt, Au, lanthanoids, lanthanides, actinides, and an alloy between two or more of the listed metals. The metallic material may be chosen from the group including nickel (Ni), palladium (Pd), platinum (Pt), tungsten (W), titanium (Ti), iron (Fe), cobalt (Co) and alloys between two or more of such transition metals. In an embodiment, the transition metals used, or their alloys, have a surface crystalline structure, for example, with crystalline clusters having micro and/or nanometric sizes, so as to ensure the adsorption of a high amount of hydrogen and the capture of possible ionic species that can be strongly attracted in a deep-energetic fashion, and even interact with the nuclei of the metal.

Although embodiments according to the present invention are illustrated in FIGS. 1 and 2 with respect to the reaction device 10, it should be understood that any suitable configuration may be used.

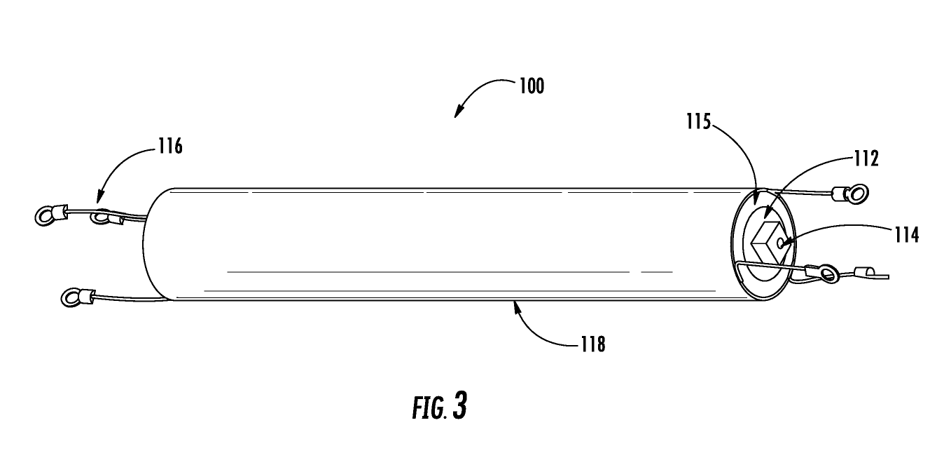

For example, as illustrated in FIGS. 3 and 4, a reaction device 100 includes a reaction chamber 112 that forms a hollow cylinder and has sealing members 114 at opposing ends thereof. The device 100 includes a housing 115 and one or more thermal units or resistance wires 116 that are formed around the housing 115 and are configured to transfer heat to the reaction chamber 112. An additional refractory layer 118 is positioned around the resistance wires 116.

In particular embodiments, the reaction chamber 112 may be formed of stainless steel or other thermally conductive materials. The housing 115 has wire grooves therein for holding the resistance wires 116. The refractory layer 118 may be a poured refractory compound, such as Durapot™ 810.

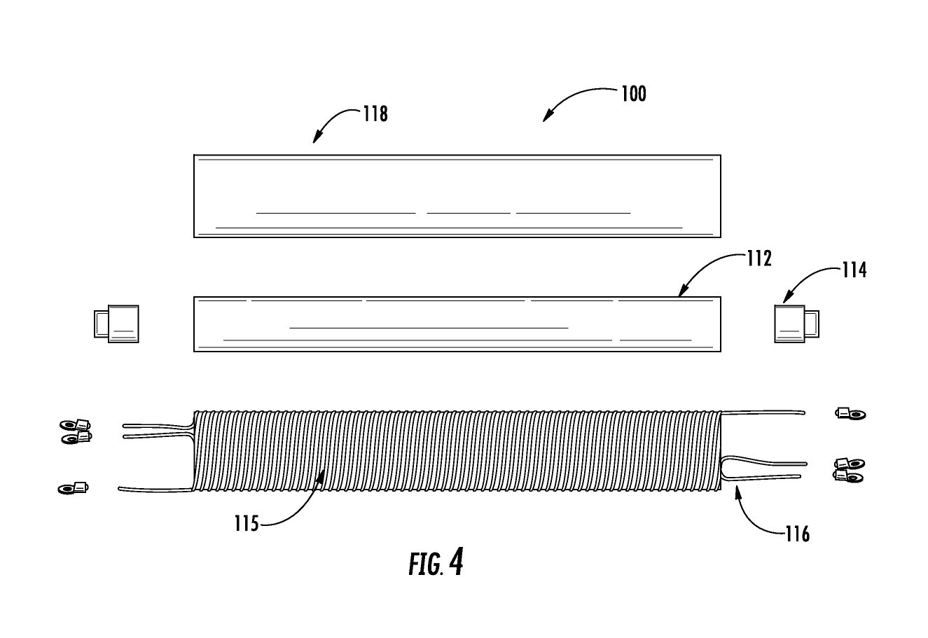

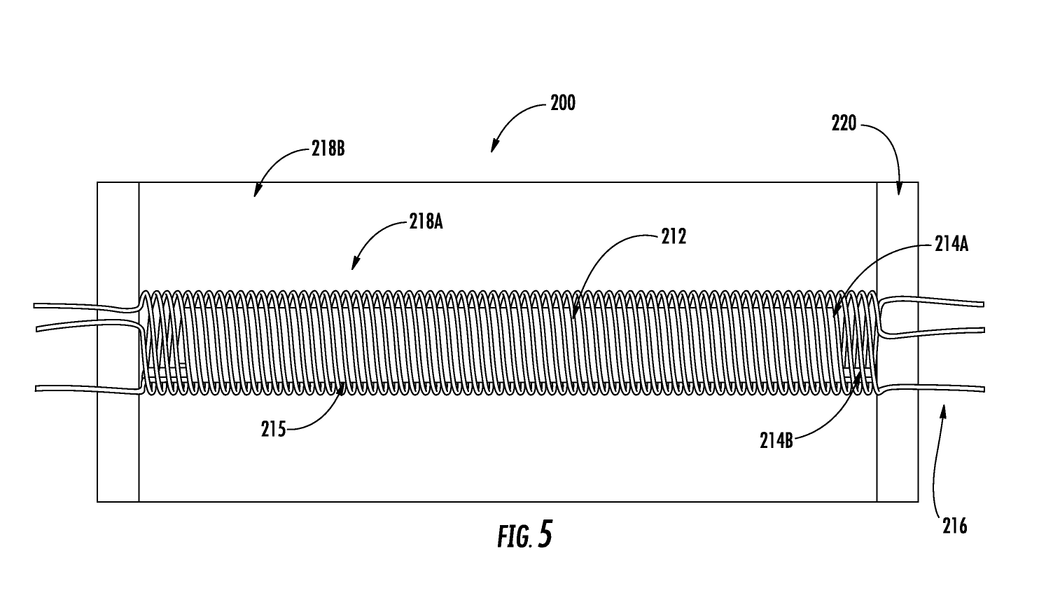

As illustrated in FIGS. 5 and 6, a reaction device 200 includes a reaction chamber 212 that forms a hollow cylinder and has sealing members 214A and refractory wedges 214B at opposing ends thereof. The device 200 includes a housing 215 and one or more thermal units or resistance wires 216 that are formed around the housing 215 and are configured to transfer heat to the reaction chamber 212. A refractory layer 218A and an additional housing 218B with supports 220 are positioned around the resistance wires 216. The reaction chamber 212 may be formed of stainless steel or other thermally conductive materials. The housing 215 has wire grooves therein for holding the resistance wires 216. The refractory layer 218A and the supports 220 may be a poured refractory compound, such as Durapot™ 810. The housing 218B may be formed of a thermally conductive material such as stainless steel.

The thermal energy from the reactor systems described herein may be used as an energy source, for example, by storing the thermal energy using known techniques, including techniques that convert the thermal energy to other forms of energy, such as mechanical energy, chemical energy, electricity (e.g., using a thermoelectric device). For example, the thermal energy may be used to produce steam to drive a turbine, etc.

Embodiments according to the present invention will now be described with respect to the following non-limiting examples.

### EXAMPLES

FIG. 7 depicts a reactor device 10 according to at least one embodiment. The device 10 is fed by electric power and is capable of emitting, as heat, more energy than the electrical power it receives by a reaction occurring within the device. Previous tests on earlier models of reactor devices highlighted the non-conventional nature of the reactive material utilized (Ref. 1). Those previous results motivated a new measurement, which differs from any former in that it was performed over a much longer period of time (32 days), and with additional instruments. More specifically, it was possible to establish that there were no external voltage (referred to herein as CC) components in the power supply. As in the previous tests, here too all measurements were limited to what could be analyzed without opening the reactor. Therefore, this test, as well as the previous ones, establishes that a new way of releasing energy is utilized for the particular reactive material used. For this reason, the new measurement was performed for a longer time span than the past tests, one month being amply sufficient. Moreover, this time interval is unrelated to the life of the reactive material included in the reactor, which was still operating in stable mode at shutdown.

Another goal was that of performing measurements with the reactor operating in a stable state. For this reason, the apparatus was run in reduced power mode. The results reported here, therefore, must not be taken to represent an evaluation of the maximum possible performance of the device even for the particular reactive material used in the test.

### Reactor Characteristics and Measurement Setup

The reactor investigated has an external appearance of an alumina cylinder, 2 cm in diameter and 20 cm in length, ending on both sides with two cylindrical alumina blocks (4 cm in diameter, 4 cm in length), which henceforth will be referred to as “caps.” Whereas the surface of the caps is smooth, the outer surface of the body of the device is molded in triangular ridges, 2.3 mm high and 3.2 mm wide at the base, covering the entire surface and designed to improve convective thermal exchange (FIG. 7; cylinder diameter is calculated from the bases of the ridges). In this way, the current embodiment of the device 10 is capable of attaining higher temperatures than earlier models, avoiding internal melting, a previously fairly frequent occurrence (Ref. 1). Each ridge is formed as a circumferential fin having a triangular profile. Other regular and/or irregular geometric profiles for the fins may be included in other embodiments.

In FIG. 7, weighing the device 10 after the test (452 g) is shown. The ridges along the body of the reactor may increase the dissipation surface for natural convection heat. The power supply cables run through the two cylindrical extremities (termed “caps”), and were cut prior to weighing. Three braided high-temperature grade Inconel cables exit from each of the two caps: these are the resistors wound in parallel non-overlapping coils inside the reactor. A thermocouple inserted into one of the caps allows the control system to manage power supply to the resistors by measuring the internal temperature of the reactor. The resistors and the copper cables of the three-phase power supply are connected outside the caps in a delta configuration. For 50 cm from the reactor, the power cables are contained in hollow alumina rods (three per side), 3 cm in diameter (See FIG. 8). The purpose of the rods is to insulate the cables and protect the connections.

FIG. 8 shows the device 10 of FIG. 8, installed on a metal frame according to at least one embodiment, with two sets of three alumina rods (one per side) thermally and electrically insulating the supply cables that run through them. On the left, the cable connecting to the K-type probe may be seen. The strut under the center of the reactor has been covered with alumina cement, which provides thermal insulation of the reactor from the strut.

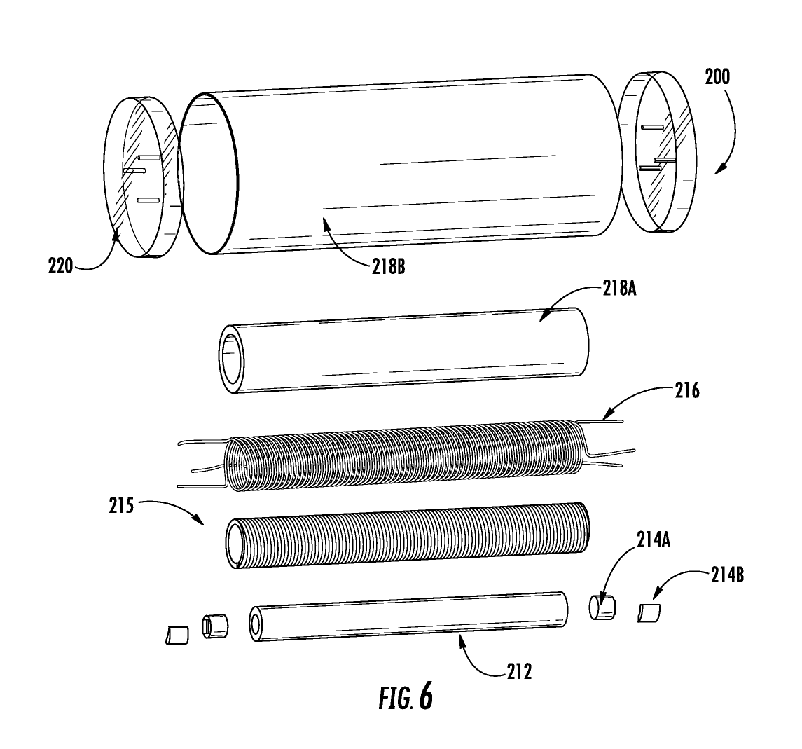

The control apparatus of the device 10 according to at least one embodiment consists of a three-phase TRIAC power regulator, driven by a programmable microcontroller. Its maximum nominal power consumption is 360 W. The regulator is signaled by a potentiometer used to set the operating point, and by the temperature determined based on a voltage produced by the reactor's thermocouple. Both the reactor and the rods lie on a metal frame, the points of contact with the frame being thermally insulated with alumina cement. The whole frame lies on an insulating rubber mat, which was lifted up before the test (FIG. 9).

FIGS. 9A and 9B show an exemplary setup for measurements. Illustrated in the foreground is a reactor control system, the two PCEs for electric power measurements, and one of the multimeters used to verify that no CC components were present. Illustrated in the background is a reactor, and the two thermal imagery cameras.

The calculation of the average power and energy production of device 10 was performed by evaluating the watts emitted both by radiation and convection. Instruments included two thermal imaging cameras to measure average surface temperatures, two power and harmonics analyzers for electrical consumption measurements, and three digital multimeters to measure for possible CC components in the power supply.

The cameras used were two Optris PI 160 Thermal Imagers, one provided with 30 degree×23 degree lens and 160×120 pixel UFPA sensors, capable of reading temperatures up to 900° C., the other with 48 degree×37 degree lens, capable of measuring temperatures up to 1500° C. The spectral range for both cameras is from 7.5 to 13 micrometers. The power analyzers were two PCE 830 units from PCE Instruments, capable of measuring and displaying, on an LCD display, electric current, voltage and power values, as well as the corresponding waveforms. These instruments are capable of reading voltage and AC current values up to five (5.0) kHz. The above choice of instruments was warranted both by the straightforwardness of the experimental setup and the precision of the instruments themselves. Designing a calorimetric measurement by means of a cooling fluid would have been decidedly much more complex, especially in the light of the high temperatures reached by the device 10.

All the instruments used were calibrated in their respective manufacturers' laboratories. A further check was made to ensure that the PCEs and the IR cameras were not yielding abnormal readings. For this purpose, before commencement of the measurements described here, both PCEs were individually connected to the power mains selected for powering the reactor. For each of the three phases, readings returned a value of 230±2V, which is appropriate for an industrial establishment power network. The IR cameras, on the other hand, were focused on circular tabs of adhesive material of certified emissivity (henceforth referred to as “dots”). The relevant readings were compared to those obtained from a thermocouple used to measure ambient temperature, and were found to be consistent with the latter, the differences being less than 1 degree Celsius.

Throughout the measurements, all the above-described instruments were connected to the same computer, wherein all the acquired data was saved. For both the PCEs and the IR cameras, data acquisition frequency was set at 0.5 Hz.

FIG. 10 shows a wiring diagram according to at least one embodiment, in which two PCEs are located where one is upstream and one is downstream from control instruments, and a TRIAC three-phase power regulator driven by a potentiometer and by the temperature read by the K-probe. The resistors are connected in delta configuration (SW=Switch, C=Connection Box). Note that the three cables running from the control system to C are referred to herein as C₁, whereas the six cables running from C to the reactor are referred to as C₂.

FIG. 10 details the electrical connections of the elements of the experimental setup. The two PCEs were inserted, one upstream and one downstream of the control unit: the first allowed measurement of the current, voltage and power supplied to the system by the power mains; the second measured these same quantities as input to the reactor. Readings were consistent, showing the same current waveform; furthermore, they enabled measurement of the power consumption of the control system, which, at full capacity, was seen to be the same as the nominal value declared by the manufacturer.

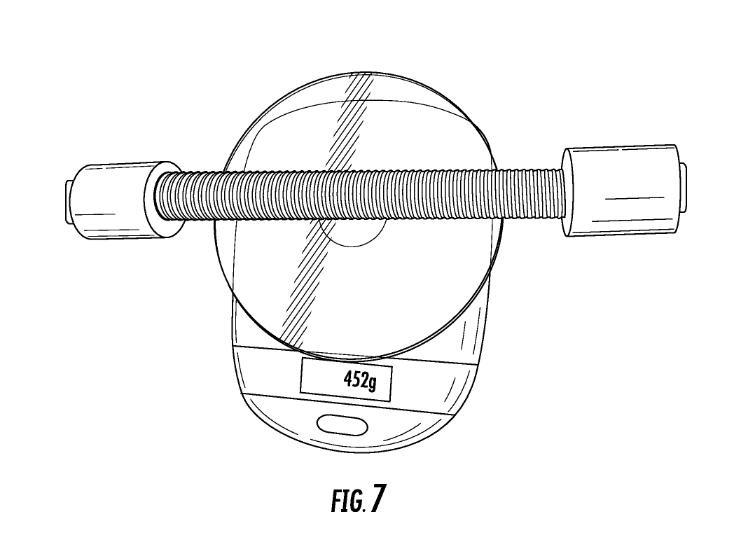

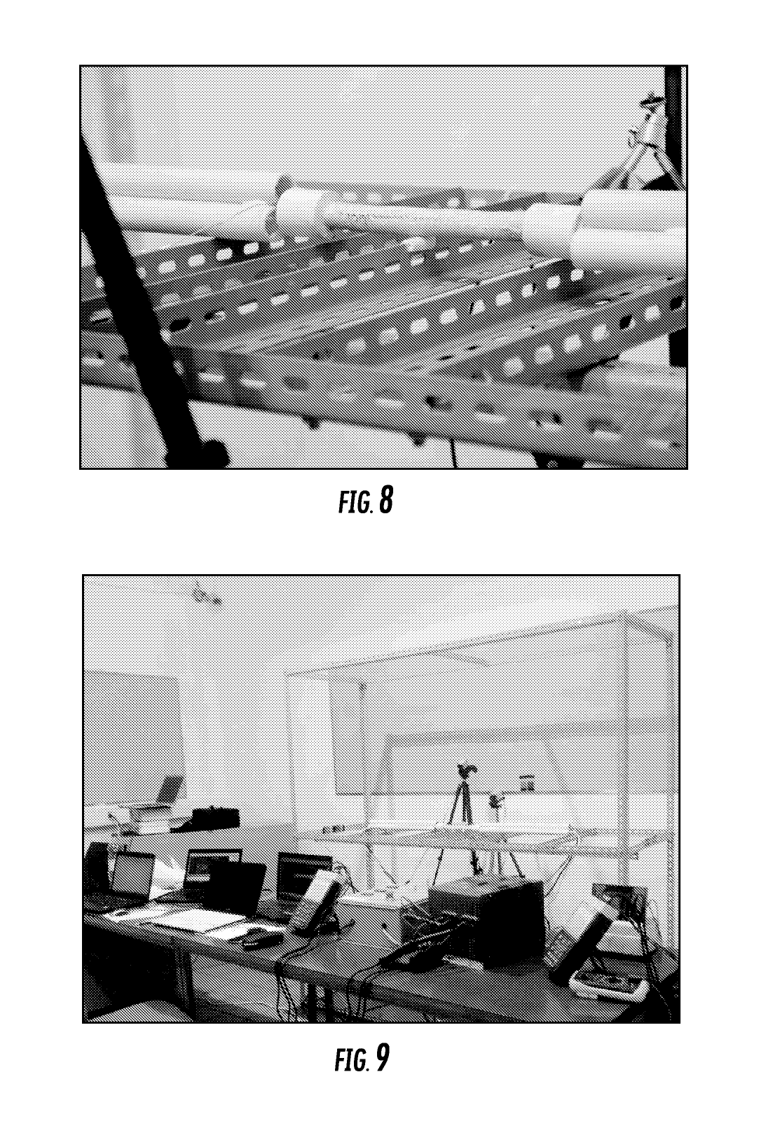

Special attention was given to measuring the current and voltage input to the system: the absence of any CC component in the power supply was verified in various occasions in the course of the test, by means of digital multimeters and supplementary clamp ammeters (FIG. 11). It was also verified that all the harmonics of the waveforms input to the system were amply included in the range measurable by the PCEs (FIG. 12). The three-phase current line supplying all the energy used for the test came from an electrical panel belonging to the establishment hosting our laboratory, to which further unrelated three-phase current equipment was connected.

FIG. 11 shows the checking of the system's input voltages and currents according to at least one embodiment. By means of digital multimeters and ammeter clamps, the absence of any CC currents was determined. As shown in FIG. 12, all the waveshape harmonics input to the system were within the PCE's measuring range.

### Measurements

The first phase of the test was dedicated to measuring the “dummy reactor”, i.e. the device 10 operating without its internal charge. Conservation of energy dictates that all power supplied to the dummy reactor from the electric power line be dissipated as thermal energy to the environment by means of thermal radiation and convection. Therefore, by comparing power input, as measured by the two power analyzers, to power output as measured, it was ascertained that no overestimation had occurred. In other words, the data relevant to the dummy reactor served the purpose of calibrating the method used, and was not meant to compare the operation of the loaded reactor to the dummy run. In fact, such a procedure would have required that the same amount of power be supplied to the dummy and to the reactor. At the start of the measurements, however, there was no way of knowing what input power the loaded reactor would have absorbed. Some Inconel cables have a crystalline structure that is modified by temperature, and are capable of withstanding high currents only if they are operated at the appropriate temperature. If these conditions are not met, microscopic melt spots may occur in the cables. Moreover, concerns of fracturing the ceramic body, due to the different configuration of the thermal generators with respect to the loaded reactor led to selecting a lower power input level. For these reasons, power to the dummy reactor was held at below 500 W, in order to avoid any possible damage to the apparatus.

The dummy reactor was switched on and gradually brought to the power level specified. Intervention was conducted to switch off the dummy, and in the following subsequent operations on the device 10: charge insertion, reactor startup, reactor shutdown and ash extraction. Throughout the test all phases of the test were monitored directly. In at least one example according to these descriptions, the reactive material comprises powdered nickel and hydrogen.

“Dots” of known emissivity, necessary to subsequent data acquisition, were placed in various places on the cable rods. It was not possible to perform this operation on the dummy reactor itself, because the temperatures attained by the reactor were much greater than those sustainable by the dots. It was also determined that the ridges made thermal contact with any thermocouple placed on the outer surface of the reactor extremely critical, making any direct temperature measurement with the required precision impossible. Therefore, in the course of the test, the camera software was set to emissivity values valid for several alumina thermal ranges. However, in order to acquire from the literature a more adequate emissivity vs. temperature trend, it was necessary to confirm some of the characteristics of the material the reactor was made of, such as its composition and degree of purity. For this purpose, upon completion of the test, a sample of the material constituting the reactor was removed. Subsequently, it was subjected to X-Ray spectroscopy. The results confirmed that it was indeed alumina, with a purity of at least 99 percent. Details of this analysis are below.

After 23 hours of operation, the dummy reactor was switched off and disconnected from the power cables, to allow for one of the caps to be opened and the reactive material to be inserted. Reactive material had been previously placed in a small envelope, weighed (about 1 g), and then transferred to a test tube. Lastly, the contents of the test tube were poured into the reactor chamber. The leads were reconnected and the cap sealed with a mixture of water and alumina powder cement. The device 10 was placed once again on its metal frame, and power was fed to it, the voltage being increased in progressive steps.

In at least one embodiment, a reactor device according to these descriptions defines a sealed vessel throughout startup and energy production stages of its utilization. In at least one other embodiment, an opening is formed or permitted such that the reactor device defines an unsealed vessel. For example, a vent may be formed by mechanical or heat process boring before or during operations and/or the device may be unsealed as directed by a control system as described above.

Upon completion of the gradual startup process procedure, the thermal camera indicated an average temperature for the body of the reactor of 1260° C., while the PCE recorded an electric power input to the device 10 fluctuating at around 810 W. Although the device 10 may operate at higher power values, the lower value was kept, and for almost 15 days no adjustments to the apparatus were made.

After this initial period, the feedback system had gradually cut back input current absorption to about 790 W. It was therefore increased, and set at slightly above 900 W, in order to obtain a second measurement point. In a few minutes, the reactor body reached a temperature close to 1400° C. Subsequent calculation proved that increasing the input by roughly 100 watts had caused an increase of about 700 watts in power emitted for the particular reactive material in the reactor chamber. Due to the speed with which the temperature had risen suggested away from any further attempt to increase power input to the reactor. Operation continued at ca. 900 W.

An ON/OFF power input mode was not induced, despite that the reactor was thought capable of operating under such conditions for as long a time as necessary. That power input mode, however, would have caused significant temperature increases during the brief intervals of time in which power was fed to the reactor.

In all the days that followed, no alterations were made to the instrumental apparatus or to the supply voltage. The dummy run was filmed and saved to a single thermography file; likewise, only one relevant file was produced by the PCE. But for the test on the device 10, the data was saved, both from the thermal camera constantly focused on the reactor body and from the PCE, on two-day intervals, yielding a total of 16 files from each instrument. This was done to avoid creating very large files, the accidental loss of which would have been inconvenient; moreover, it allowed for performing preliminary analyses on the earliest data recorded. The other IR camera was primarily used to frame the hollow rods containing the power cables, and its position was changed often in the course of the test. When experimental conditions were seen to be constant, it would be pointed towards various parts of the reactor as well as of the rods, in order to verify the symmetry of heat emission and thus yield a more comprehensive picture of the thermal behavior of the system.

About 32 days from startup, the device 10 was shut down, after gradually reducing its input power. The shutdown date had already been decided when organizing the test, and had nothing to do with the potential of the reactor, which was running normally. Therefore, no assumption may be made on the life of the particular reactive material, or on the total energy density of the reactor, and the values found are only indicative of lower limits thereof.

After cooling, the device 10 was again opened by breaking one of the caps, and the utilized reactive material (referred elsewhere herein as “ash”) were collected and put in a test tube for further analysis.

### Data Analysis Method

Radiant energy emitted both by the dummy reactor and by the device 10 was calculated by means of the Stefan-Boltzmann formula:

M=εσT⁴ (W/m²) Equation (1)

where ε is a parameter that assumes values ranging from 0 to 1, and represents the emissivity of a body, whereas σ is the Stefan-Boltzmann constant, the value of which is 5.67×10⁻⁸ (W/m²K⁴).

Knowing the value of ε may be used both for the calculation of watts emitted, and for reading temperatures with an IR camera, an instrument which does not measure the relevant parameter directly, but deduces it by means of a formula having several variables which must be supplied. Every thermal camera contains a detector where sensitive components generate an electric signal proportional to the IR radiation received. This signal is then amplified and processed by the device's electronics, and converted into an output signal proportional to the temperature of the object. This proportionality is expressed by an algorithm contingent on several parameters, such as the internal temperature of the detector (read directly by the camera sensors), ambient temperature, and the emissivity of the radiant body. The user sets the last two parameters before acquiring the data, but they may be also modified in course of analysis, because the camera software is capable of re-elaborating stored results and re-adapting them to new settings. For an in-depth description on how the cameras used by us work, see (Ref. 2)

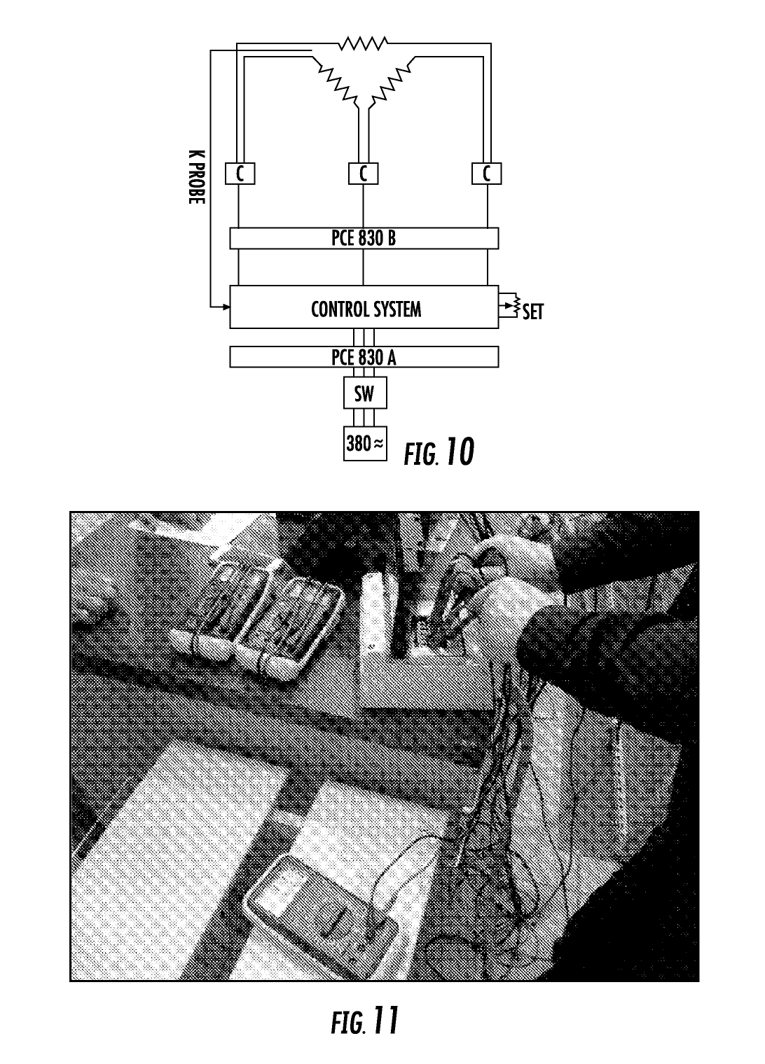

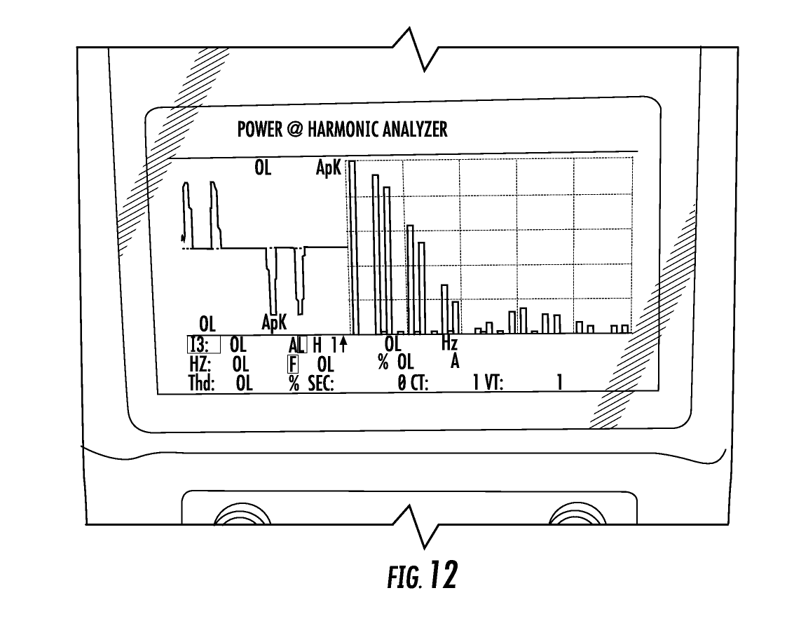

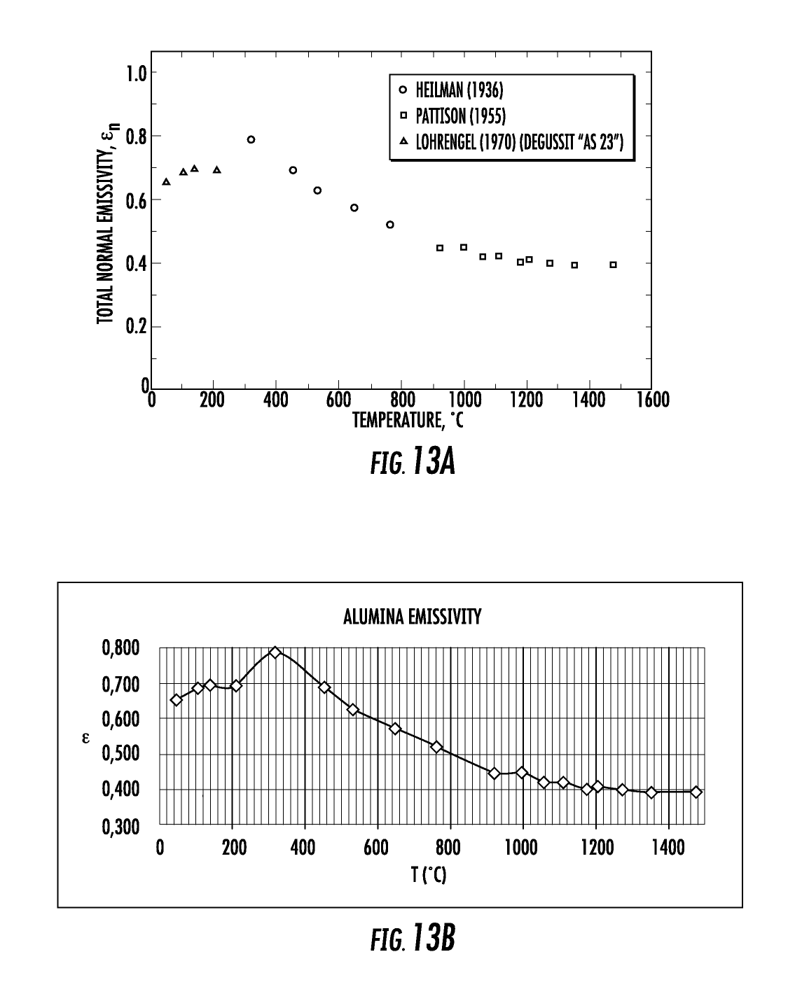

From the analyses performed on the sample taken from the reactor, it was confirmed that the material constituting the outer shell is 99 percent pure alumina; better yet, that impurities, if present, are below the experimental limit of measurement. A discrete point plot of the emissivity of said material as a function of temperature (FIG. 13A) was retrieved from the literature (Ref. 3) and the values necessary to reproduce the trend as a continuous line (FIG. 13B) were extracted. The error associated with the plot's trend has been measured at ±0.01 for each value of emissivity: this uncertainty has been taken into account when calculating radiant energy. FIG. 13B is a continuous line trend of alumina emissivity as a function of temperature, generated from data extracted from the prior art data in FIG. 13A.

During data analysis, in order to account for the several values of ε (epsilon) and, at times, an uneven distribution of heat, each thermography file was divided in an appropriate number of areas, to which the Stefan-Boltzmann formula was applied. The values for E relevant to each area were assigned recursively, by correcting the settings until the same matching between temperature and emissivity indicated by FIG. 13B was achieved. Iterative methods for determining the emissivity of an observed object are well known in the literature: some examples may be found in (Ref. 4), (Ref. 5).

The rods were made of pure alumina crystallized to a degree of fineness according to the industrial origin of their manufacture. The same emissivity trend found in the literature was taken as reference; but, by applying emissivity reference dots along the rods, the curve was adapted to this specific type of alumina, by directly measuring local emissivity in places close to the reference dots (FIG. 14).

FIG. 14 is a thermography image of rods to the right of the device 10. The circular spot is a reference “dot” (TiO₂ on Kapton film). As the dot's emissivity (0.95) is higher than that of alumina, the dot appears to be hotter. The temperature read on the dot (235 degrees Celsius) is obtained by setting the emissivity values for alumina found in the literature (Ref. 3). The difference lies within the errors associated to the measurements. An example of all these procedures is given in detail only for the dummy reactor below.

In order to calculate heat dissipated by convection, two different kinds of surfaces must be taken into consideration, the smooth cylindrical surfaces of the rods and reactor caps, and the ridged cylinder of the reactor body. If one identifies both the rods and the reactor caps as cylinders immersed in air, one may, for each of them, calculate heat Q emitted by convection per time unit by means of Newton's relation. If T_{α} indicates air temperature, A the surface area of a cylinder, and Tₛ the cylinder's temperature, Q is given as:

Q=hA(Tₛ−Tₐ)=hAΔT [W] Equation (2)

where h defines the thermal exchange coefficient [W/m²K].

Calculating h is the fundamental problem of thermal convection calculation, and has been tackled by various authors more or less empirically (See f.i. (Ref. 6), (Ref. 7), and (Ref. 8)). In the specific case of cylindrical surfaces, one of the more commonly used expressions is the following one:

h=(kCRaⁿ)/D (W/m²K) Equation (3)

where k indicates the coefficient of thermal conductivity of air (W/mK), C and n are two constants, Rα is Rayleigh's number, and D the diameter of the cylinder. Rayleigh's number is an dimensionless parameter given by the following expression:

Ra=(gβ(Tₛ−Tₐ)D^{3)/να} Equation (4)

where g (m²/s) is gravitational acceleration, β(K⁻¹) is the volumetric thermal expansion coefficient, which, for an ideal gas (applied here to air for simplicity's sake) is=1/T; next, ν (m²/s) is kinematic viscosity, and α (m²/s) is thermal diffusivity. Coefficients k, α, and ν are all temperature-dependent, and must be calculated at the so-called “film temperature” T_{f}=(Tₛ+Tₐ)/2. FIGS. 8B-8D express these trends for a range of temperatures from 100 to 1000 K and have been taken from the data reported in Appendix A of (Ref 9).

FIG. 14B shows thermal conductivity k (W/mK) of air as a function of temperature. FIG. 14C shows thermal diffusivity α (m²/s) of air as a function of temperature. FIG. 14D shows kinematic viscosity ν (m²/s) of air as a function of temperature. These plots reproduced from data found in the literature (Ref. 9). The convention used to present numerical values of the properties is illustrated by this example: for T=300 (K) this yields: k×10³=26.3 (W/mK), ν×10⁶=15.9 (m²/s), and α×10⁶=22.5 (m²/s); therefore k=0.026 (W/mK), ν=0.000016 e α=0.000023.

The Rayleigh number expresses the ratio of buoyancy forces to viscous forces, and its value is indicative of the laminar-turbulent transition, which is had for Ra>10⁹. Constants C and n are dependent on the value of Rα, according to what is expressed by Table 1 (Ref 9).

Table 1 lists values of constants C and n corresponding to variations of the Rayleigh number.

TABLE 1

| Ra | C | n |
|---|---|---|
| 10⁻¹⁰-10⁻² | 0.675 | 0.058 |
| 10⁻²-10² | 1.020 | 0.148 |
| 10²-10⁴ | 0.850 | 0.188 |
| 10⁴-10⁷ | 0.480 | 0.250 |
| 10⁷-10¹² | 0.125 | 0.333 |

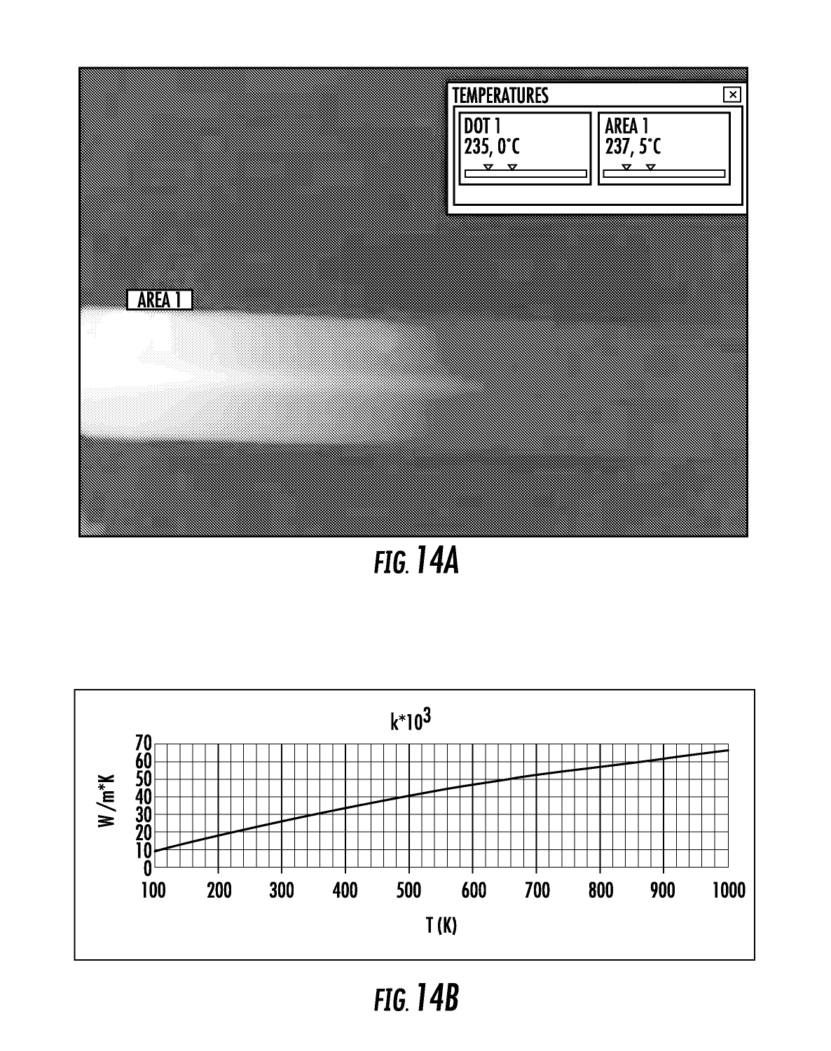

Thermal flow emitted by the body of the reactor by natural convection may be in turn calculated by an expression suitable to objects having circular fins, to which the ridges of the reactor may be compared for simplicity's sake. FIG. 15 shows a single circular fin, triangular in profile. This shape is the closest possible to the reactor's ridges, and is appropriate to represent them. FIG. 15 is a representation of a circular fin having a triangular profile. Its shape is very similar to that of the reactor ridges, and was used as a model to calculate natural convection.

To approximate the body of the reactor to that of a cylinder having N fins, each one having surface A_{f}, the total surface Aₜ is calculated:

Aₜ=NA_{f} Equation (5)

The length of the reactor body is given by L=200 mm, and that of the base of each ridge is given by δ_{b}=3.25 mm. To compare this to a finned cylinder having no space between fins, the number of ridges/fins along it is =N=L/δ_{b}≈61. For the area of each fin:

A_{f}=2π(rₐ²−r_{b}²)=3.22×10⁻⁴ (m²) Equation (6)

where r_{α} is the distance between the axis of the cylinder and the tip of a fin, =1.23×10⁻² (m), while r_{b} is the radius of the cylinder, =1.0×10⁻² (m) (FIG. 15). This formula for the area is actually fit for fins having a rectangular, not triangular, profile; this approximation is however commonly used, as one may see f.i. in (Ref. 10).

The total thermal power emitted by convection by the reactor body may be calculated in the following manner (Ref. 9):

Q=NηhA_{f} (Tₛ−Tₐ) (W) Equation (7)

assuming that coefficient h is equivalent of what one would have for a finless surface.

This coefficient h is therefore calculated as in Equation (3), referring to a cylinder having the size of the reactor but completely devoid of fins (see here (Ref. 9)). Parameter represents here the efficiency of each fin, and is an index of its thermal performance. Since the driving potential for convection is expressed by the difference in temperatures between a body and its exchange fluid, it is obvious that the maximum thermal flow for a fin would be had if its entire surface were at the same temperature as its base. However, as each fin is characterized by a finite resistance to thermal conduction, there will always be a thermal gradient along it, and the above condition is a idealization. Therefore, the efficiency for a fin is defined as the ratio of heat actually exchanged with air to its maximum ideal amount. In the case of a fin having triangular profile, one may calculate the trend of η as a function of a dimensionless parameter m, equal to:

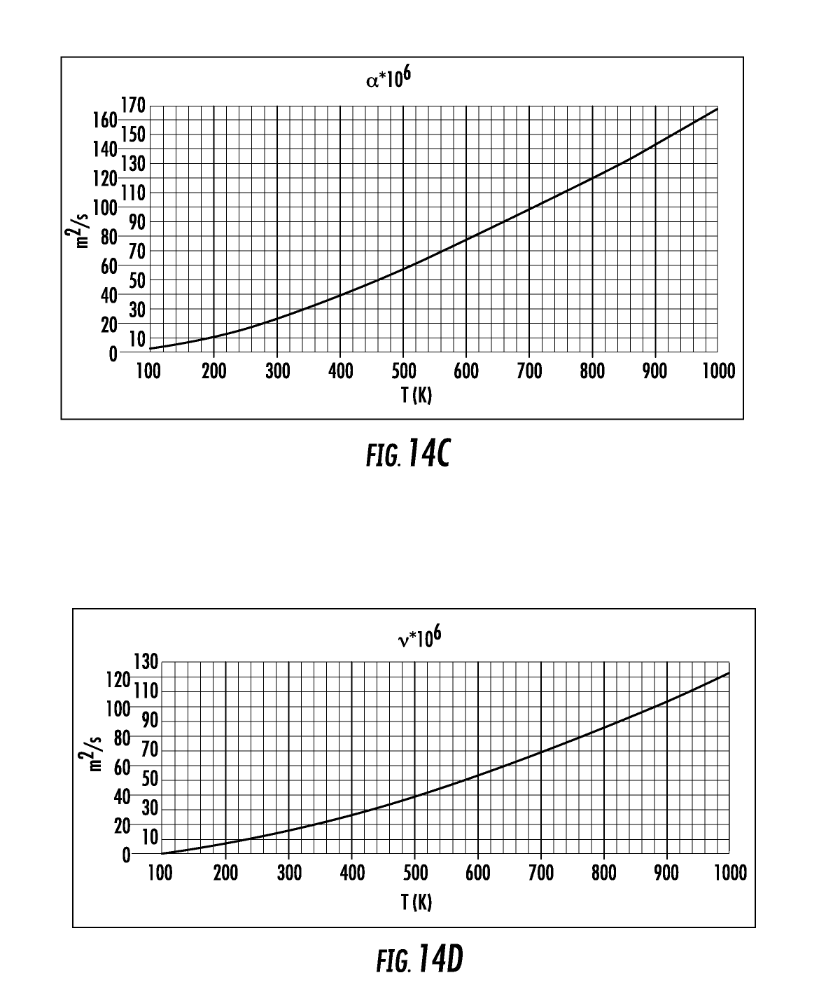

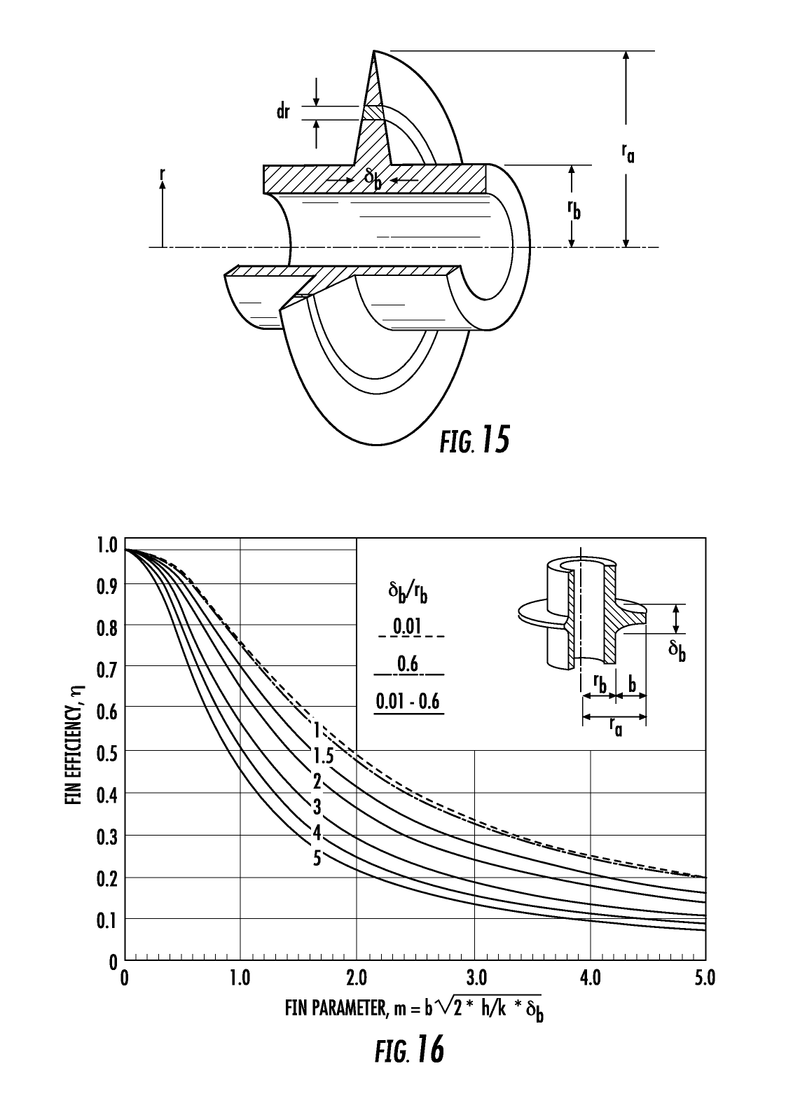

m=b(2h/kδ_{b})^{0.5} with b=rₐ−r_{b}=2.3·10⁻³ (m) Equation(8)

where k (W/mK) is the thermal conductivity of the cylinder. This trend may be seen in FIG. 16; for calculation details see (Ref. 10). FIG. 16 is a plot showing the efficiency of a circular fin having triangular profile from Ref. 10.

The cables supplying the reactor are made of copper and are several meters long; in the case of the device 10 the current flow may actually be higher than 40 A. For this reason, it is expedient to evaluate what portion of the current, fed to the system by the power mains, is dissipated by the cables as Joule heat. FIG. 10 shows the cable layout from mains to load: three copper cables exit the power regulator, one for each phase, three meters in length each, with a cross-profile of 12.00 mm². In order to allow the delta configuration connection of the resistors, each of these cables is connected to another two cables, 2 m in length each, having a cross-section of 12.45 millimeters squared.

Given that the resistivity of copper is =0.0175 Ω/m mm², one may easily deduce that the electrical resistance of the three cables exiting the regulator (Circuit 1, C₁) is =R₁=4.375·10⁻³ ω, whereas that of the cables splitting off from these (Circuit, C₂) is =R₂=2.811·10⁻³ ω.

To calculate dissipated Joule heat to the limited extent of the dummy reactor: the results relevant to the device 10 are given in Table 7, due to the fact that the average current values changed from day to day.

Measurements performed during the dummy run with the PCE and ammeter clamps allowed measurement of an average current, for each of the three C₁ cables, of I₁=19.7 A, and, for each C₂ cable, a current of I₁/2=I₂=9.85 A. The evaluation of heat dissipated by the first circuit is:

W_{C1}=3(R₁I₁²)=3(4.375×10⁻³×(19.7)²)=5.1 (W) Equation (9)

For the second circuit there is:

W_{C2}=6(R₂I₂²)=6(2.811×10⁻³ ×)9.85)²)=1.6 (W) Equation (10)

By adding the results, the total thermal power dissipated by the entire wiring of the dummy is calculated.

W_{tot.dummy}=5.1+1.6=6.7≈7 (W) Equation (11)

In the calculations that follow, relevant to the dummy reactor and the power production and consumption of the device 10, the watts dissipated by Joule heating are subtracted from the power supply values.

### Analysis of Data Obtained for the Dummy Reactor

In order to deal with the problem of radiated and natural convection heat emitted by the dummy reactor, one must first of all find its surface temperature.

FIG. 17 shows an image taken from the dummy's thermography file, processed for data analysis. Each cap has been divided into three parts, while the central body of the reactor has been divided into 10 parts. For each part, measurements are as follows:

Caps: (2π R_{cap}·L_{cap})/3=1.67×10⁻³ m² Equation (12)

Dummy reactor body: (2π R_{reactor} L_{reactor})/10=1.25×10⁻³ m² Equation (13)

where R indicates tap radius in Equation (12) and reactor body radius in Equation (13). L indicates the relevant lengths; for the reactor, the radius expressed is that of the body without the ridges.

FIG. 17 is a thermography image from the dummy reactor run. The image was divided into several areas; the most appropriate emissivity settings were applied to each area.

An emissivity value has been assigned to each area, recursively calculated on the basis of the trend in FIG. 13B. The method applied for assigning the values is set forth in Tables 2a and 2b, by using as an example the results of a randomly chosen area, in our case Area No. 5, at a randomly chosen instant.

Tables 2a and 2b provide examples of values recursively assigned to emissivity. In the first table, the initial value is set at 1.00, whereas in the second table it is set at 0.5. In both cases, one sees that the correct emissivity assigned to Area 5 is 0.69. This indicates that the method adopted here is independent of the starting value assigned to ε (epsilon).

TABLE 2a

| | T | ε for T |
|---|---|---|
| ε assigned | obtained | obtained |
| 1.00 → | 366.6 → | 0.76 |
| 0.76 → | 426.6 → | 0.71 |
| 0.71 → | 443.1 → | 0.69 |
| 0.69 → | 450.3 → | 0.69 |

TABLE 2b

[symbol]

[symbol]

indicates data missing or illegible when filed

The IR camera recording was advanced past the initial moments during which the dummy reactor was heating up, and brought to a point at which the dummy reactor was at normal capacity conditions. The file run was then stopped, and an emissivity reference value of 1 was set for each area. As one may see in the first table, for the instant chosen, the mean temperature of Area 5 indicated by the thermal camera's software is =366.6° C. for ε=1. From the curve (c vs. T), one can see that, for that mean temperature, the correct emissivity value would be 0.76; the next step is therefore changing the emissivity of area 5 according to this new value. A new estimate for the mean temperature of the area was 426.6° C., for which, according to the emissivity curve, one should have ε=0.71. This procedure is continued until one gets a correct matching between emissivity and temperature, which, in the above case of area 5, yields ε (epsilon)=0.69 and T=450.3 degrees Celsius. In order to prove that this method does not depend on the initial emissivity value chosen, Table 2b shows what happens when the initial value of ε has been nominally set at 0.5. As one may see, after a certain number of iterations, the same final result is found. After establishing what emissivity value settings were to be used for each area, the temperatures relevant to all the 23 hours of the dummy run were extracted and averaged, obtaining a single final value for each one of them (for Area 5, this was =450.3° C.). This method was applied to all the areas of the dummy reactor, as well as to the rods and to the device 10.

A possible source of error in the calculation of the mean temperatures (and, consequently, in that of emitted power) may be seen in the uncertainty with which one reads the values of curve ε (epsilon) vs. T. This uncertainty, valued at ±0.01, was used to calculate the error to be associated with each result. In the case of area 5, for instance, all calculations were first performed for ε (epsilon)=0.69, then for ε (epsilon)=0.68 (i.e. ε=0.69−0.01), and finally for ε=0.70 (i.e. ε (epsilon)=0.69+0.01). The difference between the results obtained in the last two cases, compared to the first result, is the percentage error sought. In this manner, temperature fluctuations in each area with time, for which one would have to constantly reset emissivity, are also taken into account.

The maximum value reached by area 5 during the whole measurement was 469° C., which would correspond to ε=(epsilon) 0.68, whereas the minimum value was =443° C., which would warrant ε (epsilon)=0.69.

After reckoning the average temperatures for each area, the watts emitted by radiation and convection for each area were calculated, and upon adding these, the total power dissipated by the dummy reactor was calculated. More specifically, for each area of the cap and of the reactor body, radiation values were obtained by applying Equation (1) and subtracting from the result the contribution due to ambient temperature, which during the dummy test was 21° C. (ε=0.64). Using once again Area 5 as an example and expressing all temperatures in degrees Kelvin, as the formulas require, for radiation:

$$( ɛ \times {T}^{4} - {ɛ}_{amb} \cdot {T}_{amb}^{4} ) \times σ \times Area = ( 0.69 \times {( 454.3 + 273.16 )}^{4} - 0.64 \times {( 21 + 273.16 )}^{4} \times 5.6 \; 7 \cdot {10}^{- 8} \times 1.25 \times {10}^{- 3} ) = 13.4 ( W ) \qquad Equation ( 14 )$$

For convection, Equation (2) was applied to each area relevant to the reactor caps, and Equation (7) to each area attributed to the reactor body. Taking Area 5 as an example, first calculate the heat exchange coefficient h, starting from the value assumed in this case by the Rayleigh number:

Ra=(gβ(Tₛ−Tₐ)D³)/να=28184.32

(g=9.8 (m/s²), β=1/Tₛ=19·10⁻⁴ (K⁻¹), Tₛ=727.19(K), Tₐ=294(K),

D=0.02(m), ν=40·10⁻⁶ (m²/s), α=59·10⁻⁶ (m²/s)) (Equation 15)

From Table 1 one can see that, for this value of Rα: C=0.48 and n=0.25. By Equation (3):

h=(kCRaⁿ)/D=12.75 (W/mK) Equation (16)

where the thermal conductivity of air k is =41·10⁻³ (W/mK).

Coefficients k, ν, and α were calculated by means of FIGS. 8B, 8C, and 8D, at a film temperature T_{f}=510.60 K. Furthermore, for each area of the body it is known that length L is 0.02 (m), that the number of fins is N≈6, whereas r_{b} and δ_{b} (FIG. 16) keep their previously established values (10⁻² (m) and 3.2×10⁻³ (m)).

In order to get the watts emitted by Area 5, one more parameter is lacking, namely fin/ridge efficiency, for which another parameter is needed, m, given by Equation (8). This last parameter depends on the thermal conductivity of alumina, which is, in turn, a function of its temperature. From (Ref. 3) one learns that at the average temperature of Area 5 (Tₛ=727.19(K)), k is ca. 10 (W/mK), therefore:

m=b(2h/ kδ_{b})^{0.5}=0.065 Equation (17)

From FIG. 16 one can see that for this value of m, the value of η is very close to 1 (≈0.98), which is to be expected, given the definition of efficiency and how it relates to the fairly small size of the ridges.

Now one can finally substitute all the values found in (7) and calculate heat emitted by convection by Area 5:

Q=NηhA_{f} (Tₛ−Tₐ)=10.46 (W) Equation (18)

For each cap, Equation (2) was applied, to each of the three areas attributed to each cap (A=16.7×10⁻⁴ (m^{2), D=}0.04 (m)). For instance, for cap Area 1a, by consulting FIGS. 8B, 8C and 8D, and taking into account T_{f}=453.05 (K), one gets the following values: k=37×10⁻³ (W/mK), ν=32·10⁻⁶ (m²/s) and α=47×10⁻⁶ (m²/s). In this case, the Rayleigh number and coefficient h become:

Ra=(gβ(Tₛ−Tₐ)D³)/να=292803.67 Equation (19)

h=(kCRaⁿ)/D=10.33 (W/m²K) Equation (20)

Heat emitted by convection by cap Area 1a alone is thus:

Q=hA(Tₛ−Tₐ)=5.50 (W) Equation (21)

Table 3 below shows, for each area, the values obtained for average temperature, power emitted by radiation, and power emitted by convection, when the appropriate emissivity is assigned; the last four columns give only the results relevant to the sum total of watts emitted by radiation and convection when emissivity is made higher or lower by uncertainty.

For each one of the areas that the caps and the body of the dummy reactor have been divided into, the Table 3 shows, subsequently: actual emissivity value, average temperature, power emitted by radiation, power emitted by convection, the sum of the last two values, emissivity minus uncertainty, the sum total of watts emitted if one sets “emissivity minus uncertainty,” emissivity plus uncertainty, and the sum total of watts if one sets “emissivity plus uncertainty.”

TABLE 3

| | | Average T | Radiation | Convection | TOT. | | TOT. | | TOT. |
|---|---|---|---|---|---|---|---|---|---|
| | E | (° C.) | (W) | (W) | (W) | ε − 0.01 | (W) | ε + 0.01 | (W) |
| Area 1 | 0.69 | 451.00 | 13.18 | 10.37 | 23.55 | 0.68 | 23.73 | 0.70 | 23.37 |
| Area 2 | 0.69 | 449.93 | 13.10 | 10.34 | 23.44 | 0.68 | 23.62 | 0.70 | 23.27 |
| Area 3 | 0.71 | 436.14 | 12.46 | 9.96 | 22.43 | 0.70 | 22.59 | 0.72 | 22.39 |
| Area 4 | 0.71 | 435.88 | 12.44 | 9.96 | 22.40 | 0.70 | 22.57 | 0.72 | 22.36 |
| Area 5 | 0.69 | 454.03 | 13.41 | 10.46 | 23.86 | 0.68 | 24.05 | 0.70 | 23.68 |
| Area 6 | 0.71 | 443.31 | 12.99 | 10.16 | 23.15 | 0.70 | 23.32 | 0.72 | 22.98 |
| Area 7 | 0.71 | 437.98 | 12.60 | 10.01 | 22.61 | 0.70 | 22.78 | 0.72 | 22.45 |
| Area 8 | 0.69 | 461.64 | 13.99 | 10.67 | 24.66 | 0.68 | 24.85 | 0.70 | 24.47 |
| Area 9 | 0.69 | 452.66 | 13.30 | 10.42 | 23.72 | 0.68 | 23.91 | 0.70 | 23.54 |
| Area 10 | 0.73 | 412.90 | 11.18 | 9.44 | 20.62 | 0.72 | 20.77 | 0.74 | 20.48 |
| Cap 1a | 0.79 | 338.94 | 10.07 | 5.50 | 15.57 | 0.78 | 15.64 | 0.80 | 15.50 |
| Cap 1b | 0.79 | 323.63 | 9.05 | 5.20 | 14.25 | 0.78 | 14.31 | 0.80 | 14.18 |
| Cap 1c | 0.79 | 330.38 | 9.49 | 5.33 | 14.82 | 0.78 | 14.89 | 0.80 | 14.75 |
| Cap 2a | 0.79 | 319.85 | 8.81 | 5.12 | 13.93 | 0.78 | 14.00 | 0.80 | 13.87 |
| Cap 2b | 0.79 | 323.57 | 9.05 | 5.19 | 14.24 | 0.78 | 14.31 | 0.80 | 14.18 |
| Cap 2c | 0.79 | 311.31 | 8.29 | 4.95 | 13.24 | 0.78 | 13.30 | 0.80 | 13.18 |
| TOTAL | | | 183.41 | 133.09 | 316.50 | | 318.65 | | 314.67 |

The total power emitted by the dummy reactor is 316.50 W, and the percentage error to be associated to this value is:

(318.65−314.67)/316.50=0.0126=1.26%≈1.3% Equation (22)

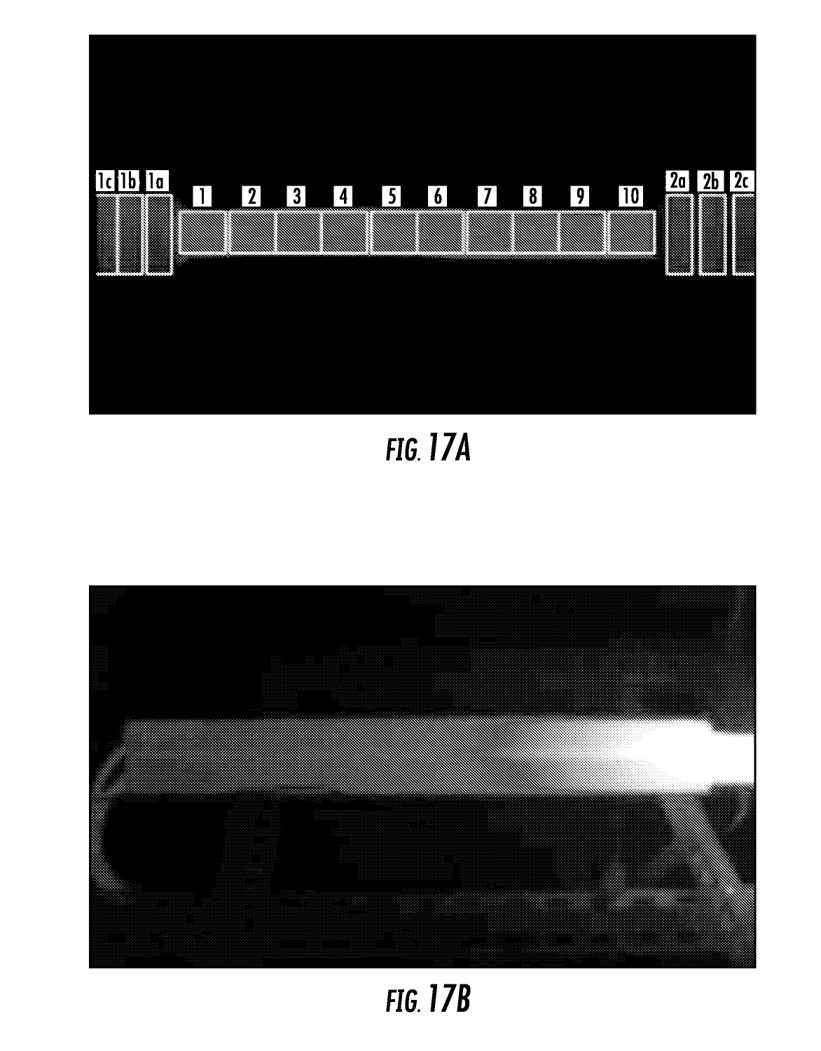

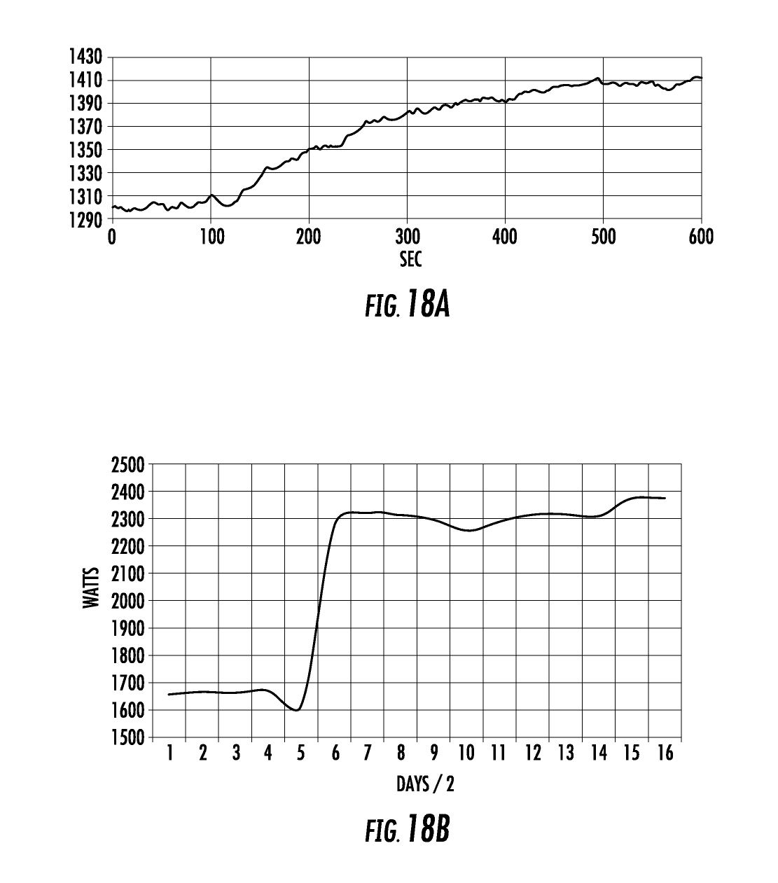

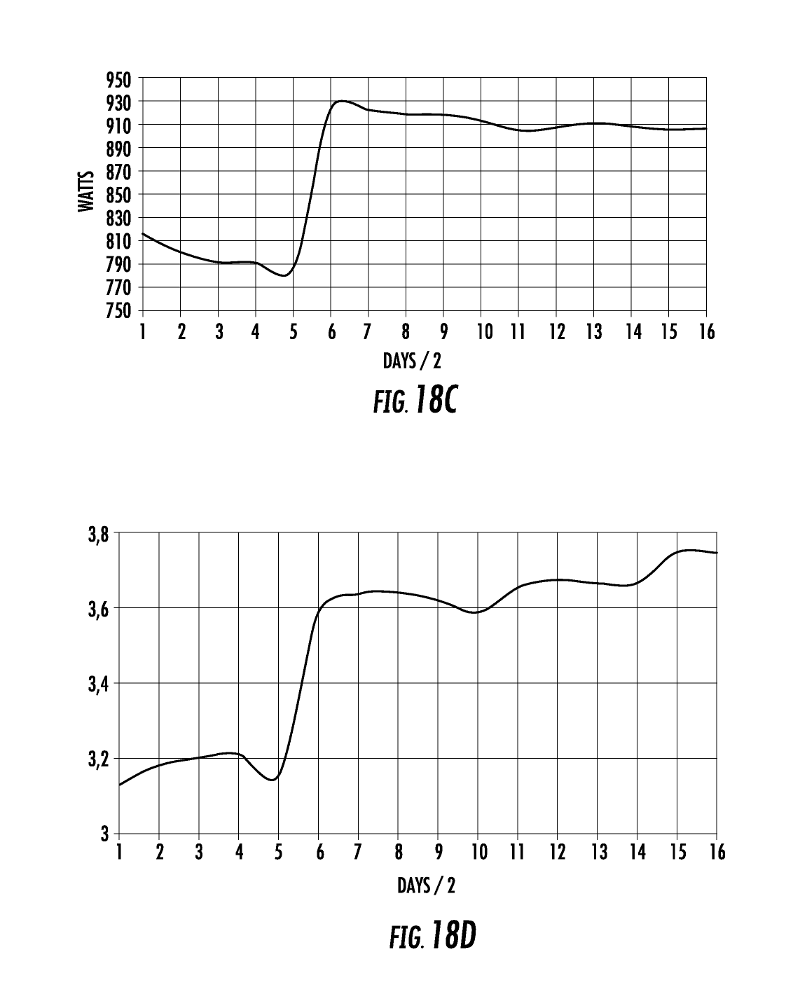

The very same process used for the dummy reactor body was used to calculate the watts emitted through radiation and convection by the rods. During the test, the rods were heated by conduction, from their being in contact with the reactor, and from the heat yielded to them by the lengths of Inconel cable external to the caps. Not only do the cables dissipate heat by Joule heating, they also distribute heat from the reactor by conduction. Here too, the thermal images of each rod were divided into 10 areas. Because the rods were placed in overlapping positions, each one of them was capable of dissipating heat to the environment for only ⅔ of its surface; moreover, whereas the temperature of the two lower rods was more or less the same, the upper rod always indicated higher temperatures. For this reason, calculations were performed on a thermography file corresponding to a side view, in which only one upper and one lower rod were visible, and to attribute to the third rod which was not framed by the camera the same values of the lower visible rod (FIG. 18). The three rods connected to the cap on the right of the dummy reactor indicated slightly higher temperatures than those connected to the cap on the left, and that this difference was within the associated error margin. It was therefore decided to perform the calculations for only one set of three rods (the cooler ones) and multiply the result by a factor of 2.

FIG. 17B is a thermography image of the set of three rods on the left of the reactor. The third rod is hidden behind the other two, so a temperature was attributed appropriately to the lower rod. The dimensions of each area are given by:

(2πR_{rod}×L_{rod})/10=4.71·10⁻³ m² Equation (23)

where R and L are the radius and the length of each rod, respectively. To each area, formulas (14) for calculating radiation and formula (18) convection were applied, substituting the appropriate values.

Table 4 shows all the results obtained for the areas of the upper rod (indicated by subscript u) and one of the lower rods (indicated by subscript d) of a set of three rods. In the columns from left to right, the first values found are relevant to the upper rod (subsequently: emissivity, average temperature, radiation power, convection power, and the sum of the last two values), followed by the values relevant to the lower rod. The sum of the results obtained for each area appears in the last line. Finally, the bottom cell of the last column of the table records the watts emitted by one entire set of three rods, a value obtained by adding the total watts produced by the upper rod, to the total watts, multiplied by two, produced by the lower rod.

Table 4 lists values that refer to one of the two sets of three dummy reactor rods. Subscript “u” refers to the uppermost rod of the set, subscript “d” to one of the two lower rods (the same results apply to the second lower rod). Each rod has been divided into 10 areas. For each area, the table indicates, subsequently: assigned emissivity, average temperature, power emitted by radiation, power emitted by convection, the sum of the last two values. The last cell of the table gives the total watts emitted by one whole set of three rods, reckoned by multiplying the results relevant to the lower rod by 2, and adding them to those of the upper rod.

TABLE 4

| | | | Rad.ᵤ | Conv.ᵤ | Tot.ᵤ | | T._{d} | Rad._{d} | Conv._{d} | Tot._{d} | Tot. 3 |
|---|---|---|---|---|---|---|---|---|---|---|---|
| Area | εᵤ | T.ᵤ (° C.) | (W) | (W) | (W) | ε_{d} | (° C.) | (W) | (W) | (W) | rods |
| 1 | 0.69 | 151.52 | 4.71 | 5.84 | 10.55 | 0.69 | 147.98 | 4.52 | 5.65 | 10.17 | |
| 2 | 0.69 | 125.13 | 3.36 | 4.45 | 7.81 | 0.69 | 118.89 | 3.07 | 4.13 | 7.20 | |
| 3 | 0.68 | 90.85 | 1.91 | 2.81 | 4.72 | 0.68 | 87.71 | 1.80 | 2.66 | 4.46 | |
| 4 | 0.67 | 68.17 | 1.15 | 1.72 | 2.87 | 0.67 | 68.15 | 1.15 | 1.72 | 2.87 | |
| 5 | 0.66 | 58.26 | 0.85 | 1.28 | 2.13 | 0.66 | 58.21 | 0.85 | 1.28 | 2.13 | |
| 6 | 0.66 | 54.12 | 0.74 | 1.11 | 1.85 | 0.66 | 52.82 | 0.71 | 1.06 | 1.77 | |
| 7 | 0.66 | 46.33 | 0.56 | 0.80 | 1.36 | 0.66 | 45.06 | 0.53 | 0.75 | 1.28 | |
| 8 | 0.66 | 40.02 | 0.42 | 0.56 | 0.98 | 0.66 | 38.89 | 0.39 | 0.52 | 0.91 | |
| 9 | 0.66 | 35.34 | 0.32 | 0.40 | 0.72 | 0.66 | 34.30 | 0.30 | 0.36 | 0.66 | |
| 10 | 0.66 | 31.82 | 0.25 | 0.28 | 0.53 | 0.66 | 31.09 | 0.23 | 0.26 | 0.49 | |
| TOT. | | | | | 33.52 | | | | | 31.94 | 9 |

The total heat emitted from both sets of three rods can now be calculated, bearing in mind how much of their surface is actually emitting heat, and the associated error percentage (1.3%):

(97.40·⅔)·2=129.86±1.3% (W) Equation (24)

By adding the watts emitted directly by the dummy reactor to watts released by conduction to the rods, one gets the dummy's thermal power output:

(316.50±4.11)+(129.86±1.68)=449.06±5.79=446±1.3% (W) Equation (25)

To compare this dissipated power with the power supply, the average of which over 23 hours of test is =(486±24) W (uncertainty here is 5% of average, calculated as standard deviation). Keeping in mind the Joule heating of the power cables discussed in paragraph 4.3, one has the following results:

| Power supply (W) | Joule heating (W) | Actual input (W) | Output |
|---|---|---|---|
| 486 ± 24 | 7 | 486 − 7 = 479 ± | 446 ± 6 |

Taking error percentages into account, one sees that where input is at a minimum possible value (455 W) and output at maximum possible value (452 W), these methods overestimate by about 3 W, i.e. 0.6%. Vice versa, where input is at maximum possible value (503 W) and output at minimum possible value (440 W) these methods underestimate the power supplied to the reactor by about 63 W, i.e. 13%.

One can therefore count on the fact that applying the very same procedure to data gathered from the device test does not lead to substantial overestimation; rather, there is a good chance that the power actually generated by the reactor device 10 is underestimated.

### Analysis of Data

Using the same procedure resorted to with the dummy reactor, the 16 files relevant to the active device test were analyzed. For each file, average power emitted by radiation and convection by the reactor were calculated, cable dissipation through Joule heating, and power transmitted to the hollow rods. For the rods, there were not 16 thermography files corresponding to those saved for the reactor, because, as mentioned above, the IR camera's position was changed frequently. Therefore analysis was conducted on several thermography files relevant to different days and positions, from which the two most representative ones for length of time and average temperatures were singled out. The first file refers to the days of the test before the day in which power supply to the reactor was increased, the second to the following days. This choice was justified by the fact that the thermal variations on the rods obtained by analyzing the file data were significant only in the comparison between the two above-mentioned stages, and lay in any case within the percentage error associated to the result (±1.3%). Once again, as in the case of the dummy reactor, the rods' symmetric geometry allowed calculations to be performed for only one set of three rods, and multiply the result by a factor of two. The results obtained are as follows:

Table 5 lists power emitted by radiation and convection by a set of three device rods (column 4) and by both sets (column 5). The values are averaged over two different periods of time: the upper row refers to the days before the day when the power supply was raised by ca. 100 watts—the lower row refers to the following days.

TABLE 5

| | | Convection | Total for 1 | Total for |
|---|---|---|---|---|
| | Radiation (W) | (W) | set of three (W) | 2 sets (W) |
| Rods, | 72.15 | 81.84 | 153.99 | 307.98 |
| 1st period | | | | |
| Rods, | 88.47 | 87.94 | 176.41 | 352.82 |
| 2nd period | | | | |

Tables 6 and 7 report all the device test results relevant to the days of testing, approximately two days for each file. The first table shows the average temperature of each cap and of the entire body of the device 10 for each of the 16 files analyzed. It should be mentioned that, as in the case of the dummy reactor, analysis on the device 10 was again performed by dividing the thermal images into 10 areas along the length of the reactor, and into three areas for each cap. In the table, however, the results relevant to each area are further averaged out, in order to facilitate reading.

In Table 7, mean power consumption, watts produced and watts dissipated by Joule heating are shown for each file. Uncertainty associated to the result is on average 5% for power consumption and 3% for watts emitted. The last two columns record COP and net production. COP is the ratio of the sum of the mean power, emitted by radiation and convection by both the device 10 and the rods, to mean power consumption of the reactor minus watts dissipated by the cables through Joule heating. It therefore gives an indicative parameter of the reactor's performance. Net production, on the other hand, is given by the difference between the total watts produced by the reactor and those consumed by it, and shows what portion of emitted power is entirely due the internal reaction of the device 10. By way of example, using the data of file No. 1 in the table:

$$\begin{matrix}COP = ( 2128.32 + 307.98 ) / ( 815.86 - 37.77 ) = 3.13 \pm ( 3 \% + 5 \% ) = 3.13 \pm 8 \% & Equation ( 26 ) \\ Net Production = ( 2128.32 + 307.98 ) - ( 815.86 - 37.77 ) == ( 2436.30 - 778.09 ) \pm ( 73.09 + 38.90 ) = 1658.21 \pm 111.99 = 1658 \pm 7 \% ( W ) & Equation ( 27 )\end{matrix}$$

Table 6 lists average temperatures of device 10 body and caps calculated for each of the 16 thermography files recorded during the test. One file corresponds to ca. two days of data logged.

TABLE 6

| File | device 10 body | Cap 1 average T | Cap 2 average T |
|---|---|---|---|
| 1 | 1260.0 | 548.5 | 539.3 |
| 2 | 1257.7 | 550.7 | 541.9 |
| 3 | 1256.0 | 548.6 | 540.5 |
| 4 | 1257.2 | 549.0 | 539.2 |
| 5 | 1243.4 | 551.5 | 543.7 |
| 6 | 1398.9 | 609.2 | 589.9 |
| 7 | 1405.5 | 609.1 | 590.1 |
| 8 | 1404.0 | 607.8 | 589.0 |
| 9 | 1401.4 | 606.1 | 588.0 |
| 10 | 1392.2 | 600.5 | 601.3 |
| 11 | 1396.4 | 608.2 | 602.2 |
| 12 | 1400.8 | 610.1 | 604.6 |
| 13 | 1401.5 | 608.5 | 604.7 |
| 14 | 1400.5 | 607.4 | 604.6 |
| 15 | 1410.2 | 614.5 | 605.8 |
| 16 | 1412.3 | 611.0 | 595.1 |

Table 7 lists, for each of the 16 thermography files recorded (ca. two days of test) and, subsequently: average power consumption of the device 10, power emitted by the device 10 by radiation, power emitted by convection, sum total of the last two values, sum total of watts emitted by both sets of rods by radiation and convection, power dissipated by Joule heating, COP, and net production.

TABLE 7

| | | | | | | Joule | | Net |
|---|---|---|---|---|---|---|---|---|
| File | Consumption | Radiation | Convection | TOT. | Rods | heating | | Production |
| No. | (W) | (W) | (W) | (W) | (W) | (W) | COP | (W) |
| 1 | 815.86 | 1740.98 | 387.34 | 2128.32 | 307.98 | 37.77 | 3.13 | 1658.21 |
| 2 | 799.84 | 1733.30 | 386.46 | 2119.76 | 307.98 | 36.98 | 3.18 | 1664.88 |
| 3 | 791.48 | 1724.95 | 385.23 | 2110.18 | 307.98 | 36.49 | 3.20 | 1663.17 |
| 4 | 790.69 | 1729.30 | 385.49 | 2114.79 | 307.98 | 36.41 | 3.21 | 1668.49 |
| 5 | 785.79 | 1676.89 | 381.43 | 2058.32 | 307.98 | 36.13 | 3.16 | 1616.64 |
| 6 | 923.71 | 2381.64 | 427.64 | 2809.28 | 352.82 | 42.43 | 3.59 | 2280.82 |
| 7 | 921.91 | 2416.68 | 429.64 | 2846.32 | 352.82 | 42.18 | 3.64 | 2319.41 |
| 8 | 918.24 | 2407.26 | 429.16 | 2836.42 | 352.82 | 41.89 | 3.64 | 2312.89 |
| 9 | 917.90 | 2392.29 | 427.82 | 2820.11 | 352.82 | 41.75 | 3.62 | 2296.78 |
| 10 | 913.40 | 2348.43 | 425.64 | 2774.07 | 352.82 | 41.93 | 3.59 | 2255.42 |
| 11 | 904.77 | 2373.08 | 427.23 | 2800.31 | 352.82 | 41.52 | 3.65 | 2289.88 |
| 12 | 906.98 | 2397.95 | 428.56 | 2826.51 | 352.82 | 41.60 | 3.67 | 2313.95 |
| 13 | 910.47 | 2401.80 | 429.87 | 2831.67 | 352.82 | 41.62 | 3.67 | 2315.64 |
| 14 | 908.13 | 2394.93 | 428.70 | 2823.63 | 352.82 | 41.55 | 3.67 | 2309.87 |
| 15 | 905.01 | 2451.10 | 432.02 | 2883.12 | 352.82 | 41.46 | 3.75 | 2372.39 |
| 16 | 906.31 | 2454.71 | 431.47 | 2886.18 | 352.82 | 41.25 | 3.74 | 2373.94 |

Table 7 shows a sharp difference between values obtained in the first ten days of the test (files 1 to 5 included), when power input to the reactor was kept at lower levels, and those obtained in the second period, in which power supply was increased by slightly more than 100 W. The effect of raising power input was an increase in power emission of about 700 W.

FIG. 18A shows the trend of average temperature for one of the areas in which the thermography file of the device 10 was divided (Area No. 5), when power input was increased. All values have been calculated by setting only one emissivity value, so as to make displaying on a continuous line possible, but the choice of ε (epsilon) is appropriate here only for the final temperatures reached after power increase. For this reason, the plot is not entirely reliable as far as the values on the y-axis are concerned: its purpose is merely that of showing how long it took the device 10 to stabilize after input current was increased. As one can see, this amounts to about 400 seconds, slightly more than six minutes.

FIG. 18A shows average temperatures of Area 5 at the time of power supply increase. All values seen here are calculated assuming the same emissivity, in order to allow visualization on a continuous line. Thus, the y-axis is an arbitrary scale by which one can determine how long it took the device 10 to reach a stable state (about 400 seconds) when input current was increased.

Another matter for consideration that stands out from the analysis of the results regards the trend of net production vs. that of consumption. There seems to be an anti-correlation between the two behaviors, which stands out as a decrease in average consumption values corresponding to increases in production averages, and vice versa. This behavior is probably due to a feedback effect driving the resistor power supply, raising it or lowering it according to the internal temperatures read by the thermocouple. The values of Table 7, relevant to net production, average consumption, and COP, are reproduced in FIGS. 12B, 12C, and 12D.

FIG. 18B shows an device net power production trend throughout the test. Each interval on the x-axis represents a time span of about two days. Net power production is given by the difference between the total watts produced by the reactor and the watts consumed by it. It shows how much emitted power is exclusively due to the internal reaction of device.

FIG. 18C shows mean power consumption of the device throughout the test. Each interval on the x-axis represents a time span of about two days.

FIG. 18D shows COP trend throughout the test. Each interval on the x-axis represents a time span of about two days. COP is the ratio of the sum of mean power emitted by radiation and convection by the device and by the rods, to the mean power consumption of the reactor minus watts dissipated by Joule heating. It gives an indication of the performance of the device.

The COP values quoted here refer only to the performance of the reactor running at the capacity selected, not at its maximum potential, any evaluation of which lies beyond the purposes for which this test was designed. Awareness of the fact that the test would have lasted a considerable length of time prompted a decision to keep the reactor running at a level of operation capable of warranting both the stability and the safety of the test. Therefore, it is not known what are the limits of the current technology are, in terms of performance and life span of the charges.

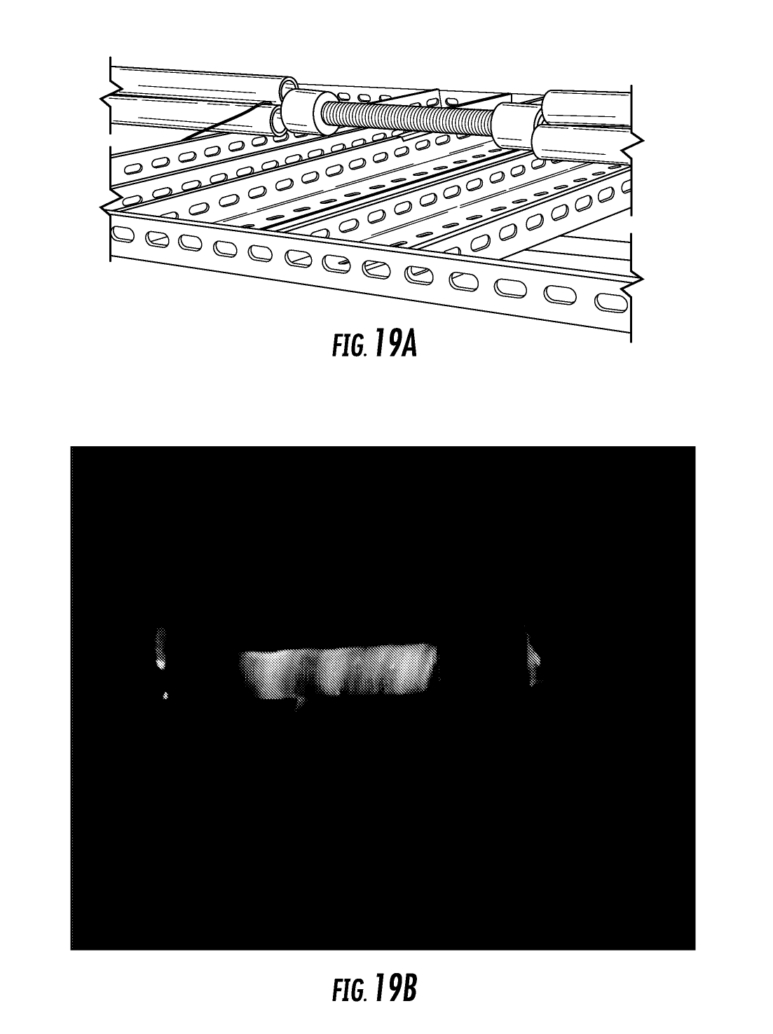

FIGS. 19A-19B show images of the device 10 operating during the test. Note the Inconel resistors exiting the caps and entering the rods, where they are connected to the copper cables of the power supply. Their high temperature is due to heat extracted from the reactor by conduction. FIG. 19B was taken in the dark, from the opposite side to that of FIG. 19A. The resistors cast a dark “shadow” on the internal energy source. One of the three sets of hollow rods is visible, and another patch of insulating alumina cement on the second metal strut in the middle, added without modifying the setup.

FIG. 20 is a Ragone plot. The net production of the device 10, the values of which may be seen in the last column of Table 7, allows one to calculate the total energy produced by the reactor during its ca. 768 hours of operation. By multiplying the value of each file by the length of time that the file refers to (48 hours) and adding the results, thus yielding:

$$( 1658.21 \times 48 ) + ( 1664.88 \times 48 ) + … + ( 2373.94 \times 48 ) = ( 1618194 \pm 10 \% ) ( Wh ) == ( 5825 \pm 10 \% ) ( MJ ) \qquad Equation ( 28 )$$

Next, one may calculate the specific gravimetric energy and the power density associated to the device to try and place it within the Ragone plot (FIG. 14), a diagram comparing the power and energy densities of several conventional sources (Ref. 11).

If one considers the weight of the charge=1 g, one gets the following values relevant to thermal energy density and power density:

$$\begin{matrix}( 1618194 / 0.001 ) = ( 1618194000 \pm 10 \% ) ( Wh \text{/} kg ) = ( 1.6 \times {10}^{9} \pm 10 \% ) ( Wh \text{/} kg ) == ( 5.8 \times {10}^{6} \pm 10 \% ) ( MJ \text{/} Kg ) & Equation ( 29 ) \\ ( 1618194000 / 768 ) = ( 2107023 \pm 10 \% ) ( W \text{/} kg ) = ( 2.1 \times {10}^{6} \pm 10 \% ) ( W \text{/} kg ) & Equation ( 30 )\end{matrix}$$

These results appear to place the device beyond any conventional source of chemical energy, as may be seen from the plot in FIG. 14. These values, though close to the energy densities of nuclear sources, such as U-235, are however lower than the latter by at least one order of magnitude. (Ref. 12)

FIG. 20 is a “Ragone plot of energy storage” (Ref. 11) that shows specific gravimetric energy and power densities relevant to various sources. The device, which would be far off the scale here, lies outside the region occupied by conventional sources.

To rule out that there were other charges inside the device reactor besides the one weighed and inserted, one may repeat the above calculations taking the weight of the entire reactor (452±1 g) into consideration:

$$\begin{matrix}( 16181947 / 0.452 ) = ( 3580075 \pm 10 \% ) ( Wh \text{/} kg ) = ( 3.6 \times {10}^{6} \pm 10 \% ) ( Wh \text{/} kg ) == ( 1.3 \times {10}^{4} \pm 10 \% ) ( MJ \text{/} Kg ) & Equation ( 31 ) \\ ( 3580075 / 768 ) = ( 4661 \pm 10 \% ) ( W \text{/} kg ) == ( 4.7 \times {10}^{3} \pm 10 \% ) ( W \text{/} kg ) & Equation ( 32 )\end{matrix}$$

Even if taken from this extremely conservative point of view, the reactor lies beyond the limits of the Ragone plot (FIG. 20).

By way of further enquiry, one may consider another kind of Ragone plot, where volumetric densities instead of gravimetric densities are expressed (FIG. 21), and calculate the reactor's position with respect to it (Ref. 13). FIG. 21 is another version of the Ragone plot of energy storage (Ref. 13) showing specific volumetric and gravimetric energy densities are given for various sources. The device, far off the scale here, lies outside the region occupied by conventional chemical sources.

Without the exact internal volume of the device, one may conservatively take into account the whole external volume of the object. The results are:

Device Volume=20π+2·16π=(163±2%) cm³=(0.163±2%) 1 Equation (33)

(5825/0.163)=(35736±12%) (MJ/I)=(3.6×10⁴±12%) (MJ/I) Equation (34)

Once again, even in the most conservative scenarios, these are values that conclude that the reactor studied here may not be considered a conventional source of energy when loaded with an appropriate reactive material such as was done in the experiments described above.

### Reactive Material Analysis

The result from the heat measurement shows a large amount of heat from the very small quantity of reactive material used confined in the small volume of the reactor. Without wishing to be bound by any particular theory, this large amount of heat is beyond what can be expected from chemical burning, which involves rearrangements of the reactive material at the atomic scale, i.e. by transforming atomic binding energies to kinetic energy. Very large energy transformations can take place when binding energies at the nuclear level are exploited, as in fusion reactions for light elements and fission reactions for heavy elements. However fusion reactions between free charged particles are unlikely at low energies due to the Coulomb barrier. The conditions for fusion reactions between particles imbedded in a specific metal compound are not expected to be very much different from those of free particles. The occurrence of fusion reactions in a metal compound having specific properties is therefore not impossible based on knowledge of the fusion process between free particles. In fact, as an example, the d(d,p)t fusion reaction cross sections have been observed [Reference 14] to depend on the temperature in deuterated metals at sub-Coulomb energies. This is an effect of screening from the electron cloud surrounding the interacting nuclei. In Astrophysics it is also known that low energy cross sections are higher than expected [see e.g. References 14,15].

In order to get information on whether any rearrangement at the nuclear level takes place in the reactive material during the burning process in the device, the isotopic composition of the reactive material before and after the burning was studied. Change in the isotopic composition of the reactive material in in the experiments described above may have its origin in a nuclear reaction. The element analyses were performed by three different external groups, each specialized in the different techniques employed. The work began with an electron microscopy (SEM) scan to study the surface morphology of the reactive material . The analyzing methods employed were X-ray Photoelectron Spectroscopy (XPS), Dispersive X-ray Spectroscopy (EDS), Secondary Ion Mass Spectrometry (SIMS) and chemical analysis from Inductively Coupled Plasma Mass Spectrometry (ICP-MS) as well as atomic emission spectroscopy (ICP-AES). The full report from these analyses is presented in detail herein.

The XPS gives information on which elements are present in the reactive material, while the SIMS and ICP-MS analyzing methods also give the isotopic composition of the nuclear species. The ICP-AES analysis also gives the masses percentage of the found elements. Both XPS and SIMS give information on which elements are present at the surface of a sample granule down to a depth of a few nanometers. The ICP-MS is an integrating method giving the average isotopic composition of the whole reactive material/ash sample being analyzed. The ICP-AES also gives the mass values in the whole sample. It is thus plausible that the four methods give rather different results depending on the sample granule chosen as well as in the case where the whole sample is used, provided that the burning process in the reactive material is not even but varies locally as observed. However, qualitatively the methods should yield the same results. It should also be noted that the total sample was about 10 mg, i.e. only a small part of the total reactive material weight of 1 g used in the reactor. The sample was taken at random from the reactive material and ash, observing care to avoid any contamination.

An arbitrary sample of different granules was chosen for the analysis, but the same samples are used for both EDS and SIMS. The reactive material contains natural nickel powder with a grain size of a few microns. The existence of natural Nickel content is confirmed by all four analyzing methods being used. In addition the reactive material is found to be mixed with a component containing hydrogen, i.e. possibly a chemical hydride. From all combined analysis methods of the reactive material, significant quantities of Li, Al, Fe and H, in addition to Ni, were found. Moreover from the EDS and XPS analysis one finds large amounts of C and O. The quantities of most elements differ depending on which granule is analyzed. In addition to these elements there are small quantities of several other elements, but these may be considered as impurities.

The reactive material may be mixed with the standard Lithium Aluminum Hydride, LiAlH₄. An ICP-AES analysis shows that the mass ratio between Li and Al is compatible with a LiAlH₄ molecule. This compound can be used to produce free hydrogen by heating. Hydrogen may be included. The reactive material need not include deuterium. The SIMS illustrates this. The other methods are insensitive to both hydrogen and deuterium.

The ash has a different texture than the powder-like reactive material by having grains of different sizes, possibly developed from the heat. The grains differ in element composition, but the limited amount of ash available make it impossible to analyze more grains with SIMS. The main result from the sample is that the isotopic composition deviates from the natural composition for both Li and Ni.

The Lithium content in the reactive material may have a natural composition, i.e. ⁶Li 7% and ⁷Li 93%. However at the end of the run a depletion of ⁷Li in the ash was revealed by both the SIMS and the ICP-MS methods. In the SIMS analysis the ⁷Li content was 7.9% and in the ICP-MS analysis it was 42.5%. This result shows that the burning process in E-Cat changes the reactive material at the nuclear level, i.e. nuclear reactions have taken place. It is notable that also in Astrophysics, a ⁷Li depletion is observed [see e.g. Reference 17].

Considering Li and disregarding for a moment Coulomb barrier, the depletion of ⁷Li might be due to the reaction p+⁷Li→⁸Be→⁴He+⁴He. The momentum mismatch in the first step before ⁸Be decays can be picked up by other particles in the vicinity. In this case, the large kinetic energy of the Ile (distributed between 7 and 10 MeV) is transferred to heat in the reactor via multiple Coulomb scattering in the stopping process. One can then estimate how much this reaction contributes to the total heat being produced in the test run. There is about 0.011 gram of ⁷Li in the 1 gram reactive material utilized in the experiments. The ICP AES analysis confirmed this. If each ⁷Li nucleus releases about 17 MeV the total energy available becomes 0.72 MWh. This is less than the 1.5 MWh produced in the 32 day run, so more energy has to come from other reactions, judging from this estimate.

Another change in the ash as compared to the unused reactive material is the identified change in the isotope composition of Ni. The unused reactive material has a natural isotope composition as confirmed by both SIMS and ICP-MS, i.e., ⁵⁸Ni (68.1%), ^{α}Ni (26.2%), ⁶¹Ni (1.1%), ⁶²Ni (3.6%), and ⁶⁴Ni (0.9%), whereas the ash composition from SIMS is: ⁵⁸Ni (0.8%), ⁶⁰Ni (0.5%), ⁶¹Ni (0%), ⁶²Ni (98.7%), ⁶⁴Ni (0%), and from ICP-MS: ⁵⁸Ni (0.8%), ⁶⁰Ni (0.3%), ⁶¹Ni (0%), ⁶²Ni (99.3%), ⁶⁴Ni (0%). The SIMS and ICP-MS give the same values within the estimated 3% error in the given percentages.

There is also an isotope shift in Nickel. There is a depletion of the ⁵⁸Ni and ⁶⁰Ni isotopes and a buildup of the ⁶²Ni isotopes in the burning process. It is noted that ⁶²Ni is the nucleus with the largest binding energy per nucleon. The origin of this shift cannot be understood from single nuclear reactions involving protons. With alpha particles colliding with Ni one can in principle raise the atomic mass number by 4 via exciting ⁵⁸Ni to ⁶²Zn, which then via positron emission decays back to ⁶²Cu and ⁶²Ni, but that is unlikely to occur due to an enormous Coulomb barrier to merge ⁴He and Ni. Besides, with this reaction one can also go to stable Zn isotopes, which are not found in the ash.

It should be pointed out that the fusion towards heavier isotopes of Nickel releases energy. For example the reaction p+⁵⁸Ni→⁵⁹Cu+J and ⁵⁹Cu decaying back to ⁵⁹Ni via β⁺ emission releases 3.4 MeV. Even if that particular reaction is excluded, since gammas are not observed, this number can be used for each step towards ⁶²Ni and there is about 0.55 gram Ni in the reactive material of the experiments (confirmed based on the information from ICP-AES. It is found then that there is about 2.2 MWh available from the Nickel transformations. Accordingly, from Nickel and

Lithium together there is about 3 MWh available, which is twice the amount given away in the test run. Consequently, it can be concluded that the amount of reactive material may be compatible with the energy release being measured.

An isotope shift appears to have occurred in Lithium and Nickel. If nuclear transitions are prevalent in the burning process it is expected that radiation is emitted. Neutrons, charged particles and gammas are not observed from the device. Furthermore, the spent reactive material was found inactive right after the run was stopped. Nuclear reactions in the reactor should be followed by some radiation, and at least some of that radiation should penetrate the reactor wall and be possible to detect. Even in the case discussed above with two rather high energy helium nuclei in the final state, which stop in the reactor, one can expect that some helium nuclei during the stopping process undergo some nuclear reaction, e.g. inelastic scattering of ⁴He on Li, Al or Ni which then subsequently decays to their ground state respectively via gamma emission. To get a free neutron is however not currently believed to be kinematically possible with the 10 MeV alpha available. There appears to be an absence fo any nuclear radiation from the burning process.

### SUMMARY

A 32-day test was performed on a reactor, capable of producing heat by exploiting a reaction primed by heating and some electro-magnetic stimulation. In the past years, the same collaboration has performed similar measurements on other reactors, but differing both in shape and construction materials from the one studied here. Those tests have indicated an anomalous production of heat, which prompted a new, longer test. The purpose of this longer measurement was to verify whether the production of heat is reproducible in a new improved test set-up, and can go on for a significant amount of time. In order to assure that the reactor would operate for a prolonged length of time, power was supplied to the device in such a way as to keep it working in a stable and controlled manner. For this reason, the performances obtained may not reflect the maximum potential of the reactor, which was not an object of study here.

The measurement, based on calculating the power emitted by the reactor through radiation and convection, gave the following results: the net production of the reactor after 32 days' operation was (5825±10%) [MJ], the density of thermal energy (if referred to an internal charge weighing 1 g) was (5.8·10⁶±10%) [MJ/kg], while the density of power was equal to (2.1·10⁶±10%) [W/kg]. These values appear to place the device beyond other known conventional sources of energy. Even if one conservatively repeats the same calculations with reference to the weight of the whole reactor rather than that of its internal charge, one gets results confirming the non-conventional nature of the form of energy generated by the device, namely (1.3·10^{4±}10%) [MJ/kg] for thermal energy density, and (4.7·10³±10%) [W/kg] for power density.

The quantity of heat emitted constantly by the reactor and the length of time during which the reactor device was operating appears to rule out a chemical reaction as underlying its operation with reactive material such that used in the experiments. This is emphasized by the fact that the performance of the reactor stands considerably more than two orders of magnitude from the region of the Ragone plot occupied by conventional energy sources.

The reactive material generating the excessive heat includes Lithium and Nickel content having a natural isotopic composition before the run, but after the 32 days run the isotopic composition has changed both for Lithium and Nickel. Such a change can take place via nuclear reactions. It would thus appear that nuclear reactions have taken place in the burning process. This is also what can be suspected from the excessive heat being generated in the process.

In summary, the device gives heat energy compatible with nuclear transformations when suitably reactive material, and further operates at low energy and gives neither nuclear radioactive waste nor emits radiation. The experimental test results show heat production that appear beyond chemical burning, and that the reactive material appears to undergo nuclear transformations. If sustainable, the device has a potential may become a useful energy source.

### Alumina Sample Analysis

In order to confirm the nature of the material covering the reactor, a sample from one of the ridges or fins was analyzed. To prevent contamination, the fragments were placed on an X-Ray crystallography slide and attached with high vacuum grease, avoiding further handling.

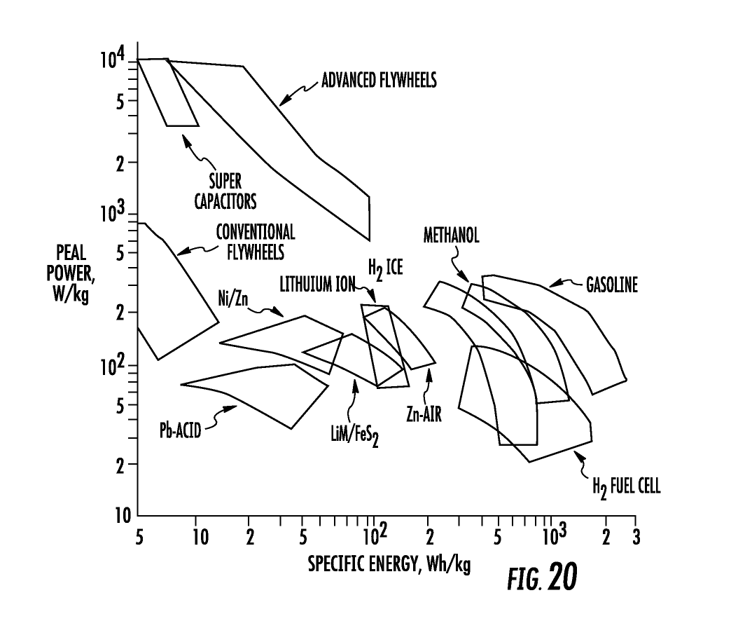

FIG. 22 shows a slide with fragments attached, the fragments being a sample of material taken from one of the fins of the device 10 reactor of FIG. 7. A spectrum collected of the slide sample is shown in FIG. 23.

A listing of the measurements parameters used follows:

### Anchor Scan Parameters:

| | |
|---|---|
| Scan Axis | Gonio |
| Start Position [°2Th.] | 30.0000 |
| End Position [°2Th.] | 100.0000 |
| Step Size [°2Th.] | 0.0200 |
| Scan Step Time [s] | 4.0000 |
| Scan Type | Continuous |
| Offset [°2Th.] | 0.0000 |
| Divergence Slit Type | Fixed |
| Divergence Slit Size | 1.0000 degree |
| Specimen Length [mm] | 10.00 |
| Receiving Slit Size [mm] | 0.1000 |
| Measurement Temperature | 25.00 degrees Celsius |
| Anode Material | Cu |
| K-Alpha1 [Å] | 1.54060 |
| K-Alpha2 [Å] | 1.54443 |
| K-Beta [Å] | 1.39225 |
| K-A2/K-A1 Ratio | 0.50000 |
| Generator Settings | 45 mA, 45 kV |
| Diffractometer Type | Rigaku DMAX-IIIC Diffractometer |
| | Number 1 |
| Goniometer Radius [mm] | 240.00 |
| Dist. Focus-Diverg. Slit [mm] | 91.00 |
| Incident Beam Monochromator | No |
| Spinning | No |

Table 8 lists peaks automatically identified by analysis software.

TABLE 8

| Pos. | Height | FWHM | d-spacing | Rel. Int. | Tip width | |
|---|---|---|---|---|---|---|
| [°2Th.] | [cts] | [°2Th.] | [Å] | [%] | [°2Th.] | Matched by |
| 35.1845 | 338.49 | 0.0787 | 2.55074 | 47.87 | 0.0945 | 00-042-1468; 01-071- |
| | | | | | | 1127 |
| 35.4333 | 331.09 | 0.0590 | 2.53340 | 46.83 | 0.0708 | 01-071-1127 |
| 37.7784 | 134.95 | 0.0590 | 2.38136 | 19.09 | 0.0708 | 00-042-1468 |
| 41.7685 | 9.88 | 0.2362 | 2.16263 | 1.40 | 0.2834 | 00-042-1468; 01-071- |
| | | | | | | 1127 |
| 43.3784 | 220.16 | 0.0960 | 2.08430 | 31.14 | 0.1152 | 00-042-1468 |
| 43.5753 | 280.81 | 0.2362 | 2.07706 | 39.72 | 0.2834 | 01-071-1127 |
| 52.5804 | 221.39 | 0.0960 | 1.73915 | 31.31 | 0.1152 | 00-042-1468 |
| 52.7386 | 185.66 | 0.0720 | 1.73862 | 26.26 | 0.0864 | |
| 57.6591 | 634.55 | 0.1200 | 1.59745 | 89.74 | 0.1440 | 01-071-1127 |
| 61.3068 | 71.69 | 0.1440 | 1.51086 | 10.14 | 0.1728 | 00-042-1468; 01-071- |
| | | | | | | 1127 |
| 66.5421 | 186.63 | 0.1920 | 1.40412 | 26.40 | 0.2304 | 00-042-1468 |
| 683309 | 707.06 | 0.0720 | 1.37165 | 100.00 | 0.0864 | 00-042-1468 |
| 68.5276 | 456.75 | 0.0720 | 1.37160 | 64.60 | 0.0864 | |
| 74.3991 | 5.84 | 0.5760 | 1.27408 | 0.83 | 0.6912 | 00-042-1468 |
| 76.9444 | 185.35 | 0.0960 | 1.23816 | 26.21 | 0.1152 | 00-042-1468 |
| 77.1776 | 144.63 | 0.1920 | 1.23500 | 20.46 | 0.2304 | 00-042-1468; 01-071- |
| | | | | | | 1127 |
| 80.8221 | 12.13 | 0.3840 | 1.18825 | 1.72 | 0.4608 | 00-042-1468; 01-071- |
| | | | | | | 1127 |
| 84.4963 | 10.90 | 0.3840 | 1.14570 | 1.54 | 0.4608 | 00-042-1468 |
| 86.4385 | 18.75 | 0.4800 | 1.12487 | 2.65 | 0.5760 | 00-042-1468 |
| 89.0923 | 77.91 | 0.1680 | 1.09810 | 11.02 | 0.2016 | 00-042-1468 |
| 91.2842 | 17.82 | 0.6720 | 1.07736 | 2.52 | 0.8064 | 00-042-1468 |
| 95.2206 | 96.29 | 0.1200 | 1.04295 | 13.62 | 0.1440 | 00-042-1468 |
| 95.5698 | 57.60 | 0.1440 | 1.04006 | 8.15 | 0.1728 | |

Table 9 lists components identified from the peak configuration of Table 8

TABLE 9

| | | | Compound | Displacement | | Chemical |
|---|---|---|---|---|---|---|
| Visible | Ref. Code | Score | Name | [°2Th.] | Scale Factor | Formula |
| * | 00-042-1468 | 75 | Alumina | 0.000 | 0.357 | Al2O3 |
| * | 01-071-1127 | 54 | Corundum | 0.000 | 0.211 | Al2O3 |

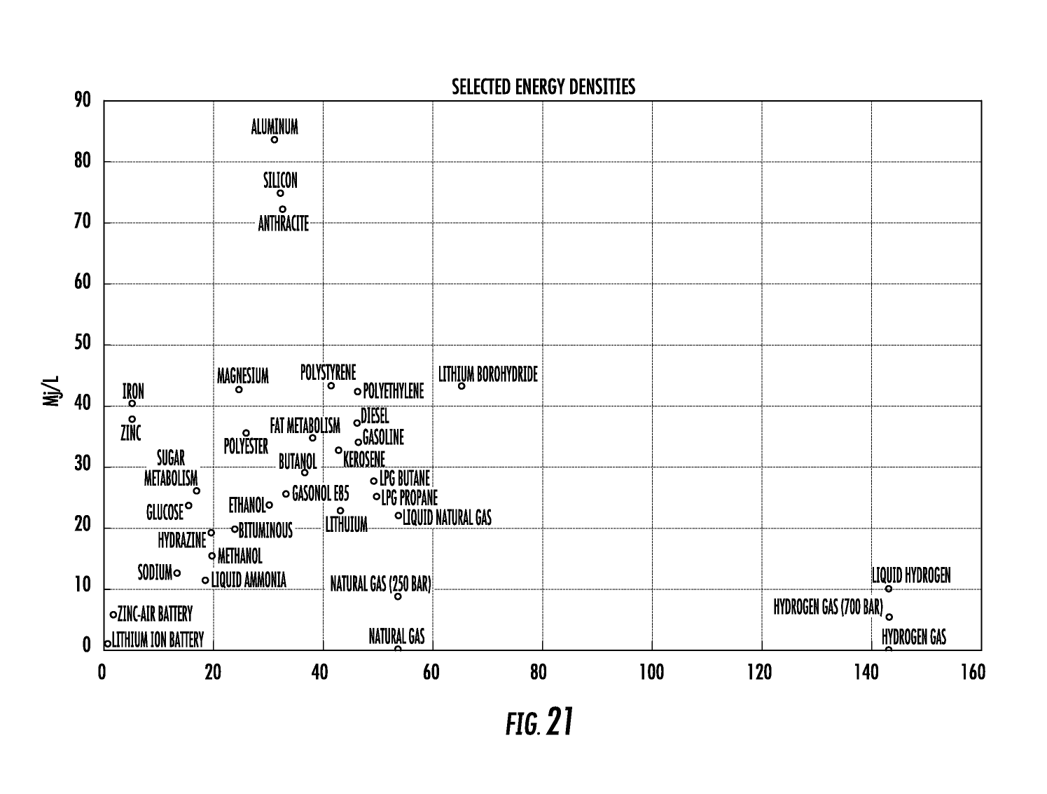

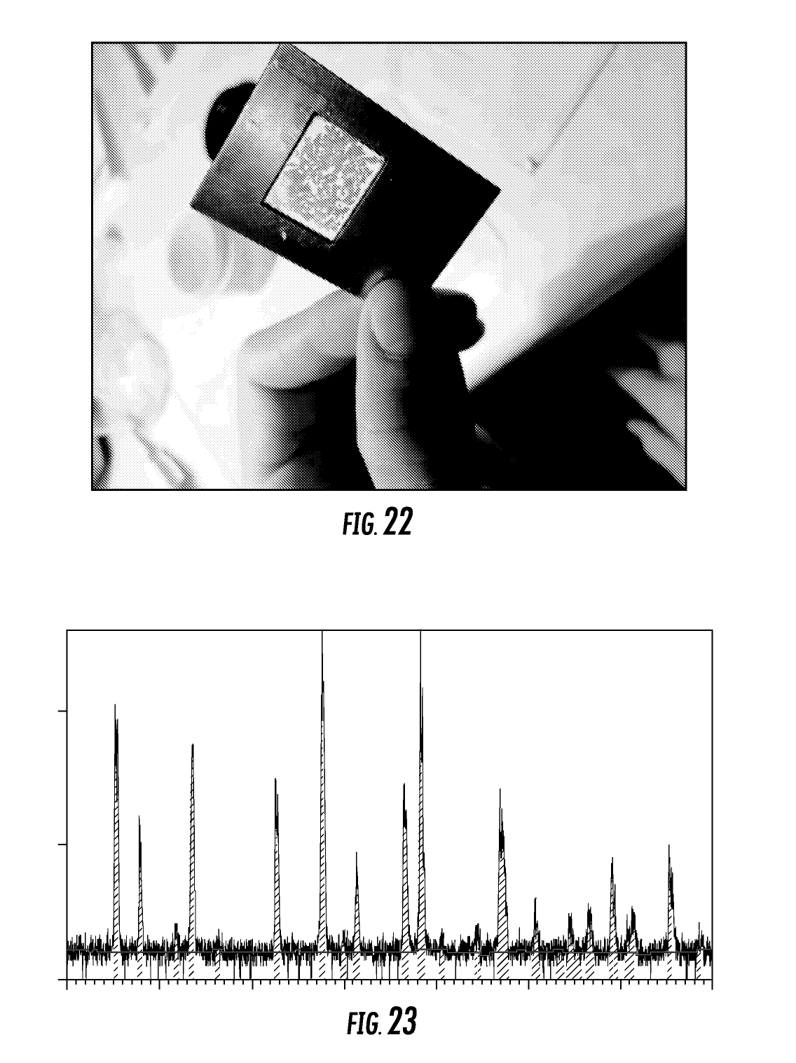

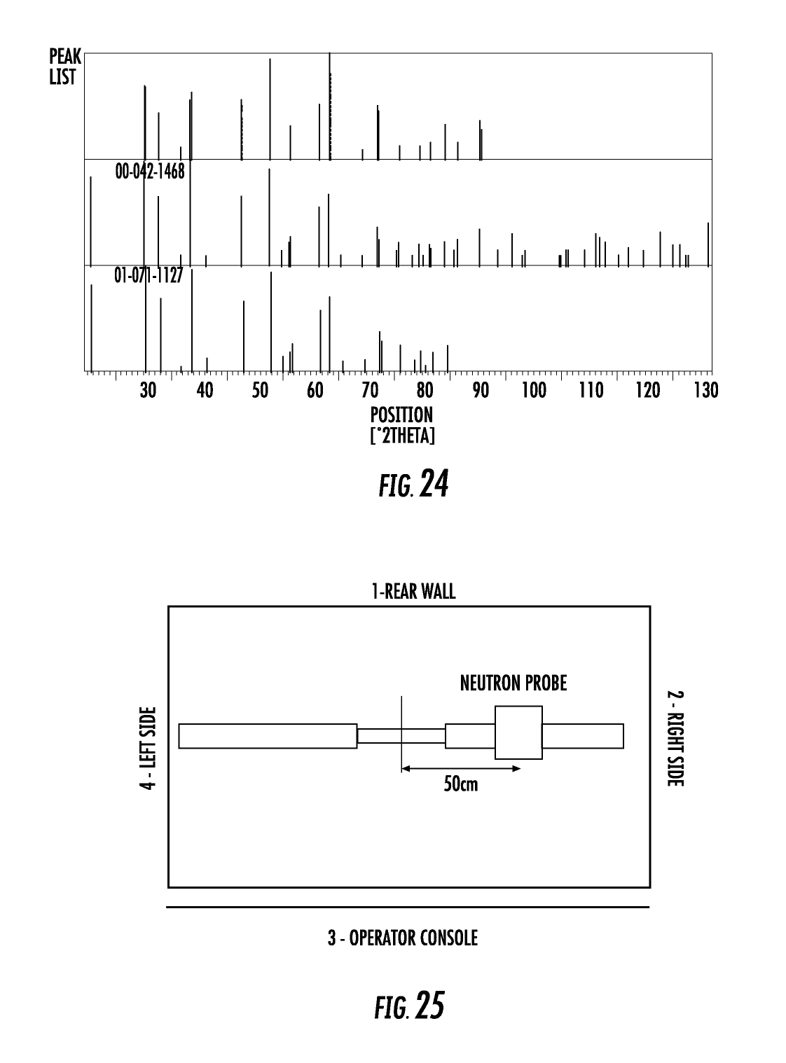

FIG. 24 shows peaks found compared to the two materials identified through the database. In conclusion, within the limits of the instrument's sensitivity range, the sample appears to be constituted of aluminum dioxide, Al₂O₃.

### Radiation Measurements During the Long-Term Test of the Prototype

### Materials and Methods

In order to avoid potential source or risk for the operators and the population around the prototype during the long duration test a different kind of radiation in wide range of energy was measured. The hypothesis that the prototype can produce a radiation field is due to the unconventional energy that has been produced with it. To ensure that this process did not involve ionizing radiation evaluations were performed on different types of radiation in a wide spectrum and wide energy. The measurements are divided temporally in before, during and after the use of the prototype. In the “before” and “after” evaluation, the gamma and alpha/beta field evaluation are made on the material used inside the prototype. In the “during” evaluations, the gamma and neutron field are performed around the system.

The measurement does not take into account the interaction of the photons, charged particles or neutron produced by the materials inside the apparatus during the using and cannot be traced back to the production of ionizing radiation from the inside of the prototype.

The radiation measurement protocol is structured as follows: The comparison of the CPM collected during the test with the CPM is an index of low flounce radiation field. The active probes and the TLD positions were chosen to be at the closest position accessible by operators around the support frame. The radioisotope presence in the material used before and after the experiment was evaluated with a Geiger scanner in ratemeter mode. The background radiation has been measured both in the plant and in the laboratory, at a distances d>30 m from the room where the test took place.

The measurements were performed with the following instrumentation:

### 1. LUDLUM 2241 Scaler-Ratemeter (sin 214522):

Scintillation probe (2.5×2.5 cm) (Dia×L) (Nal)T1 Ludlum 44-2 (PR-227268);
Energy range: 50 keV −2 MeV;
Exposure sensitivity: 19.9 CPM/nSv/hr 137Cs gamma);
Integration time: 2 s.
Rate meter Alarm and Alert: 0.2 μSv/h
Calibration factors on ¹³⁷Cs supplied by the factory (04/2012)
Constancy evaluation of gamma response factor with ¹³⁷Cs radiation source before and after the test
The rate meter has a serial RS-232 bluetooth connection to a PC logger.
   2. LUDLUM 2221 Sealer/Ratemeter SCA (sin202347):
Neutron Radiation Detector (neutron recoil scintillator) Prescila 42-41 (PR256816)
Sensitivity declared : 350 cpm per mrem/h;
Calibrations at ENEA calibration service:
Jun. 14, 2012 (N° 03N12) wi 1 h AmBe source (E.,.-,=4.4 MeV)
F=0.028 μS′vl h/ CPM I equivalent to 36 cpm per μSv/h
28/0112008 wi 1h Pu-Li source (Eₙₑᵤₜᵣₒₙₛ=0.54 MeV)
F=0.067 μS′vl h/CPM equivalent to 15 cpm per μSv/h
Angular dependence and temperature dependence as in FIG. 24
   3. LUDLUM 2241 Sealer-Ratemeter (sin214522):
Geiger Probe Ludlum 44-9 (PR-226527);
Energy range: energy dependent
Exposure sensitivity: 3300 cpm/mR/hr (¹³⁷Cs gamma);
Integration time: 2 s.
Background (typical): 60 CPM
Rate meter Alarm and Alert: 0.3 μSv/h
Calibration factors on ¹³⁷Cs supplied by the factory (0412012)
Constancy evaluation of gamma response factor with ¹³⁷Cs before and after the test.

### 4. Termoluminescent Dosimeters LiF:V

TDL Reader: Vinteen Toledo 654
Calibration field: IEC 61267—Code RQR5—2.45 mm A1 HVL
Calibration dose: 0.050±0.005 mGy
Calibration factor: individual for each TDL
   Mean counts of the sample: 1613 cou
   Mean F value of the sample 0.031 μC
Extended error on the dose measure at 0.050 n
2 TDL for each position of measurement
Calibration made before and after the measurement

### Results

Evaluation of radionuclides presence:

The material that compound the prototype, including the material inside, are controlled before and after the test in order to avoid the presence of radioisotope contamination. These measurements are performed with the Geiger probe in rate meter configuration on at least 20 points as shown in Table 10:

TABLE 10

CPM (mean values)

| | BEFORE | AFTER |
|---|---|---|
| Background radiation | 51 (σ = 11) | 53 (σ = IO) |
| in laboratory | | |
| Background radiation | 47 (σ = 13) | 48 (σ = 13) |
| in plant | | |
| Naked “Hot-Cat” | 53 (σ = 11) | 51 σr = 12) |
| Sample of inside | 55 (σ = 14) | 52 (σ = 15) |
| reactor material | | |

The reactor's inside material has been scanned in a low background container (5 cmPB) with the Nal probe and this measure did not show any γ/X activity of the sample.

### Gamma/X Monitoring During the Test:

The monitoring of the photonic dose field is made with passive and active dosimeters. During the 34 days of running, 16 TLD dosimeters recorded the dose (4 for each side) and 4 TLD were used as control placed at d>50 cm (FIG. 25).

The term luminescent reading values and relative doses are presented in the following (Table 11):

TABLE 11

| Position | Counts | Dose (mGvl |
|---|---|---|
| 1—Rear wall | 2539 | 0.079 ± 0.024 |
| 2—Right side | 2477 | 0.077 ± 0.023 |
| 3—Operator consolle | 2411 | 0.075 ± 0.022 |
| 4—Left side | 2553 | 0.079 ± 0.024 |
| Control | 2385 | 0.074 ± 0.022 |

The comparison of the absolute dose to the control dosimeters (background) shows that the incremental dose due the test is less than 0.03±0.01 mGy for all the positions considered.

### Neutron Field Monitoring During the Test:

The neutron dose field evaluation was made on a 5 hour interval. This interval is considered representative of the rest of the test. The measurements were performed in scaler mode on 60 s integration time on the detailed number of runs as shown in Table 12.

TABLE 12

| | Number | Mean | Standard |
|---|---|---|---|
| | of runs | Counts | deviation |
| Background radiation in the laboratory | 20 | 14.1 | σ = 4.3 |
| Background radiation in plant | 45 | 13.8 | σ = 3.9 |
| 50 cm from the center of the prototype | 95 | 16.9 | σ = 4.1 |

### Alumina Sample Analysis

In order to confirm the nature of the material covering the reactor, a sample from one of the ridges was analyzed. To prevent contamination, the fragments were placed on an X-Ray crystallography slide and attached with high vacuum grease, avoiding further handling (See FIG. 22).

The measurements parameters used are shown in Table 13.

TABLE 13
Anchor Scan Parameters:

| | | | |
|---|---|---|---|
| Scan Axis | Gonio | Start Position [°2Th.] | 30.0000 |
| End Position [°2Th.] | 100.0000 | Step Size [°2Th.] | 0.0200 |
| Scan Step Time [s] | 4.0000 | Scan Type | Continuous |
| Offset [°2Th.] | 0.0000 | Divergence Slit Type | Fixed |
| Divergence Slit Size [°] | 1.0000 | Specimen Length [mm] | 10.00 |
| Receiving Slit Size [mm] | 0.1000 | Measurement Temperature [° C.] | 25.00 |
| Anode Material | Cu | K-Alpha1 [Å] | 1.54060 |
| K-Alpha2 [Å] | 1.54443 | K-Beta [Å] | 1.39225 |
| K-A2/K-A1 Ratio | 0.50000 | Generator Settings | 45 mA, 45 kV |
| Diffractometer Type | Rigaku | Diffractometer Number | 1 |
| DMAX-IIIC | | | |
| Focus-Diverg. Slit [mm] | 91.00 | | |
| Incident Beam Monochromator | No | Spinning | No |

### Graphics: (Bookmark 2)

Referring to FIG. 23, analysis software automatically identified the peak list shown in Table 14 from its database:

TABLE 14
Peak List:

| Pos. | Height | | d-spacing | Rel. | Tip width | |
|---|---|---|---|---|---|---|
| [°2Th.] | [cts] | FWHM | [Å] | Int. | [°2Th.] | Matched by |
| 35.1845 | 338.49 | 0.0787 | 2.55074 | 47.87 | 0.0945 | 00-042-1468; 01-071- |
| | | | | | | 1127 |
| 35.4333 | 331.09 | 0.0590 | 2.53340 | 46.83 | 0.0708 | 01-071-1127 |
| 37.7784 | 134.95 | 0.0590 | 2.38136 | 19.09 | 0.0708 | 00-042-1468 |
| 41.7685 | 9.88 | 0.2362 | 2.16263 | 1.40 | 0.2834 | 00-042-1468; 01-071- |
| | | | | | | 1127 |
| 43.3784 | 220.16 | 0.0960 | 2.08430 | 31.14 | 0.1152 | 00-042-1468 |
| 43.5753 | 280.81 | 0.2362 | 2.07706 | 39.72 | 0.2834 | 01-071-1127 |
| 52.5804 | 221.39 | 0.0960 | 1.73915 | 31.31 | 0.1152 | 00-042-1468 |
| 52.7386 | 185.66 | 0.0720 | 1.73862 | 26.26 | 0.0864 | |
| 57.6591 | 634.55 | 0.1200 | 1.59745 | 89.74 | 0.1440 | 01-071-1127 |
| 61.3068 | 71.69 | 0.1440 | 1.51086 | 10.14 | 0.1728 | 00-042-1468; 01-071- |
| | | | | | | 1127 |
| 66.5421 | 186.63 | 0.1920 | 1.40412 | 26.40 | 0.2304 | 00-042-1468 |
| 68.3309 | 707.06 | 0.0720 | 1.37165 | 100.00 | 0.0864 | 00-042-1468 |
| 68.5276 | 456.75 | 0.0720 | 1.37160 | 64.60 | 0.0864 | |
| 74.3991 | 5.84 | 0.5760 | 1.27408 | 0.83 | 0.6912 | 00-042-1468 |
| 76.9444 | 185.35 | 0.0960 | 1.23816 | 26.21 | 0.1152 | 00-042-1468 |
| 77.1776 | 144.63 | 0.1920 | 1.23500 | 20.46 | 0.2304 | 00-042-1468; 01-071- |
| | | | | | | 1127 |
| 80.8221 | 12.13 | 0.3840 | 1.18825 | 1.72 | 0.4608 | 00-042-1468; 01-071- |
| | | | | | | 1127 |
| 84.4963 | 10.90 | 0.3840 | 1.14570 | 1.54 | 0.4608 | 00-042-1468 |
| 86.4385 | 18.75 | 0.4800 | 1.12487 | 2.65 | 0.5760 | 00-042-1468 |
| 89.0923 | 77.91 | 0.1680 | 1.09810 | 11.02 | 0.2016 | 00-042-1468 |
| 91.2842 | 17.82 | 0.6720 | 1.07736 | 2.52 | 0.8064 | 00-042-1468 |
| 95.2206 | 96.29 | 0.1200 | 1.04295 | 13.62 | 0.1440 | 00-042-1468 |
| 95.5698 | 57.60 | 0.1440 | 1.04006 | 8.15 | 0.1728 | |

Peak configuration allowed the identification of the following components:

TABLE 15
Identified Patterns List:

| | | | | Displacement | Scale | |
|---|---|---|---|---|---|---|
| Visible | Ref. Code | Score | Compound | [°2Th.] | Factor | Chemical Formula |
| * | 00-042-1468 | 75 | Alumina | 0.000 | 0.357 | Al2O3 |
| * | 01-071-1127 | 54 | Corundum | 0.000 | 0.211 | Al2O3 |

FIG. 24 shows peaks found compared to the two materials identified through the database. The conclusion is that within the limits of the instrument's sensitivity range, the sample appears to be constituted of aluminum dioxide, Al₂O₃

### Investigation of a Reactive Material and Its Reaction Product Using SEM/EDS and ToF-SIMS

### Background

Samples of reactive material were investigated before and after an experiment performed in Lugano, Switzerland. The purpose of the present investigation is to study which elements occur in the samples.

### Experiment

### Material

Two types of powder samples were investigated. The first sample, called fuel, is declared to contain Ni and some additions of H and Li. The second sample, called ash, is the reaction product of the fuel powder from an experiment performed in Lugano. The powder samples were mounted on a carbon adhesive sticker before analysis. The samples analyzed with SEM/EDS and ToF-SIMS were received mounted and analyzed as-received.

### Surface Characterization Techniques

SEM/EDS Scanning electron microscopy (SEM) was used to study the surface morphology of the samples. The SEM analyses were performed with a Zeiss Ultra 55 field emission gun scanning electron microscope (FEG-SEM) equipped with an Oxford Instruments Inca energy dispersive X-ray spectroscopy (EDS). Imaging was performed by using the secondary electron detector (SEI-mode). All EDS analyses where performed by using an accelerating voltage of 20 kV of the primary electrons.

ToF-SIMS All time-of-flight secondary ion mass spectrometry (ToF-SIMS) analyses were performed with a PHI TRIFT II instrument using a 15 keV pulsed liquid metal ion source isotopically enriched in ⁶⁹Ga. In this system, the secondary ions are accelerated up to ˜3 keV before being deflected by 270° by three electrostatic hemispherical analyzers. Both positive and negative spectra were obtained using a 600 pA d.c. primary ion beam pulsed with a frequency of 8 kHz (m/z=0.5-1850 amu), a pulse width of 18 ns (˜1 ns bunched) and rastered over a surface area of 100×100 μm². The mass resolution at mass +28 amu (Si⁺) was around m/Δm=1900. All spectra were carefully calibrated using the exact masses of peaks of known composition such as ⁷Li⁺ (7.0160 amu), Na⁺ (22.9898 amu), Al⁺ (26.9815 amu), 58Ni⁺ (57.9353 amu) etc. Peak identification was done on the basis of the exact mass of the secondary ions.

### Results and Discussion

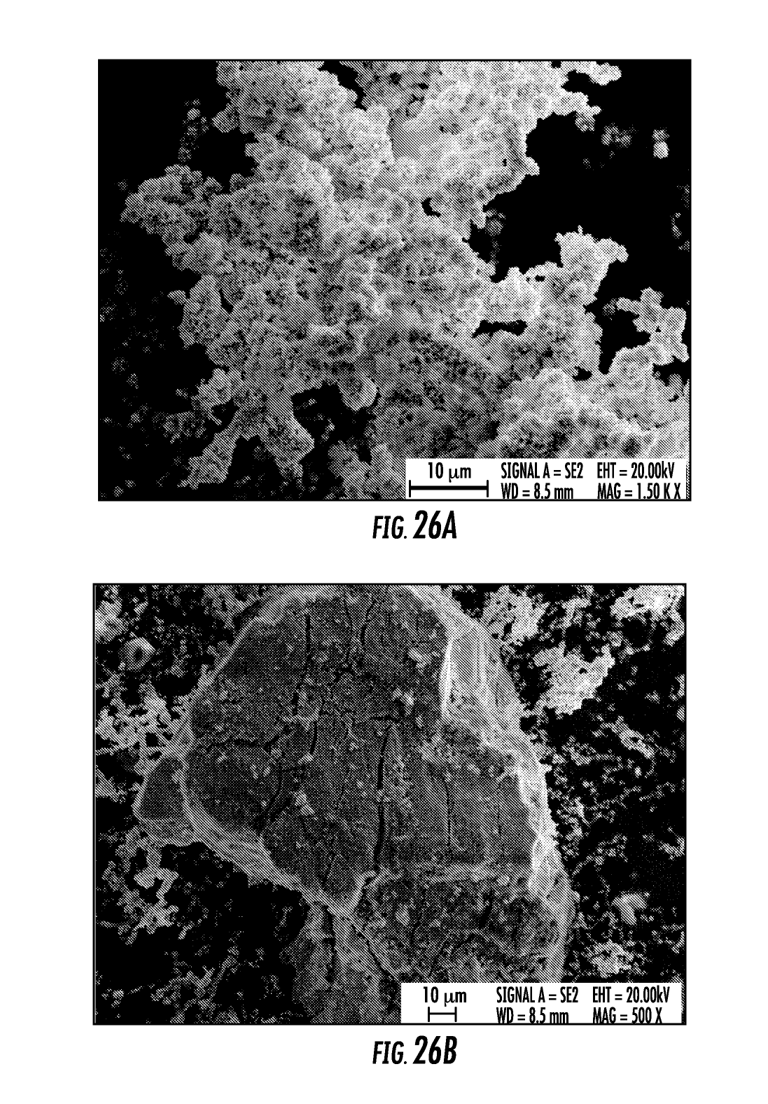

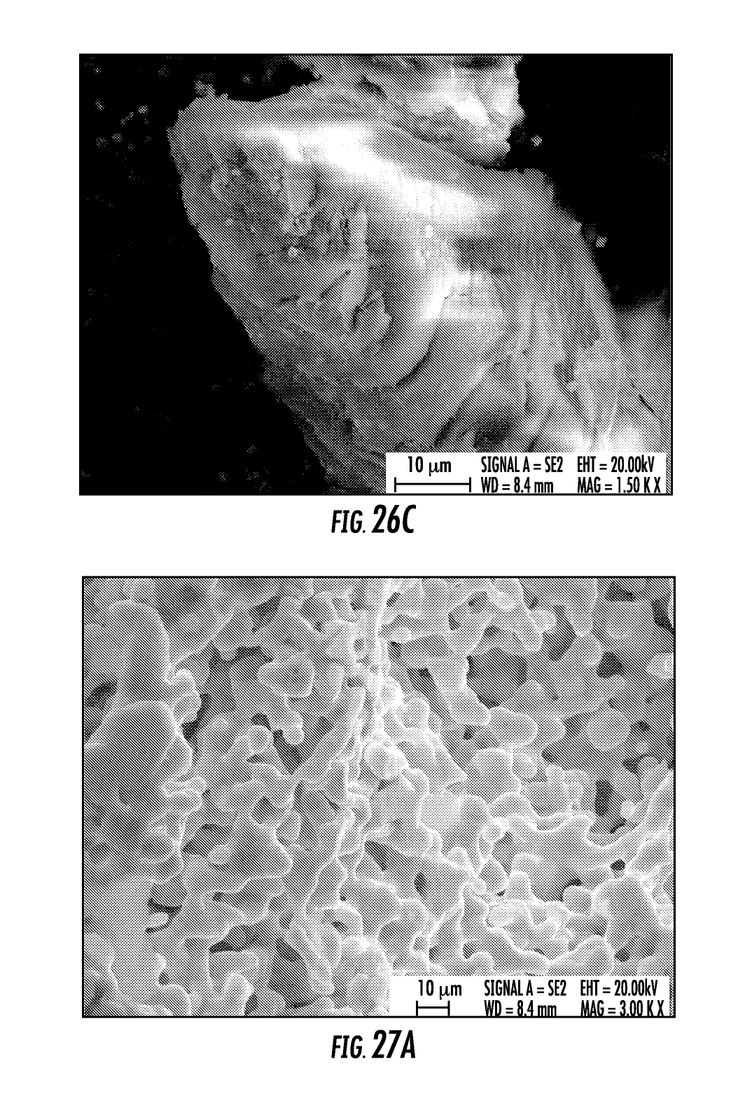

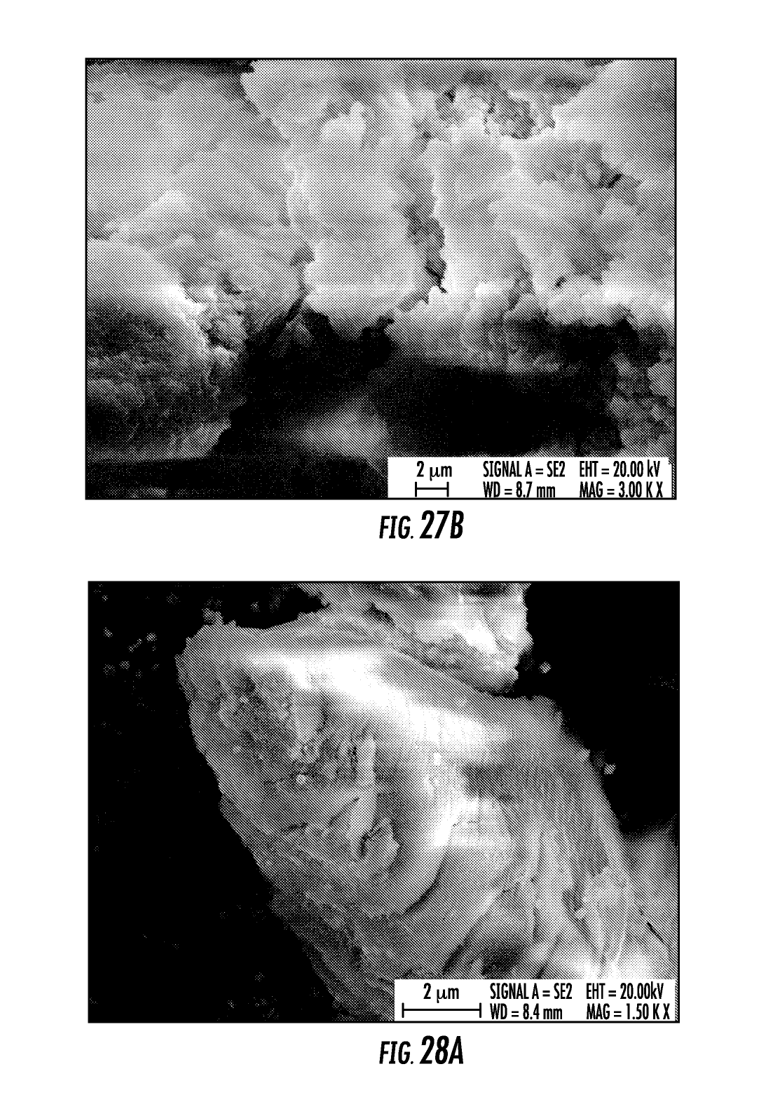

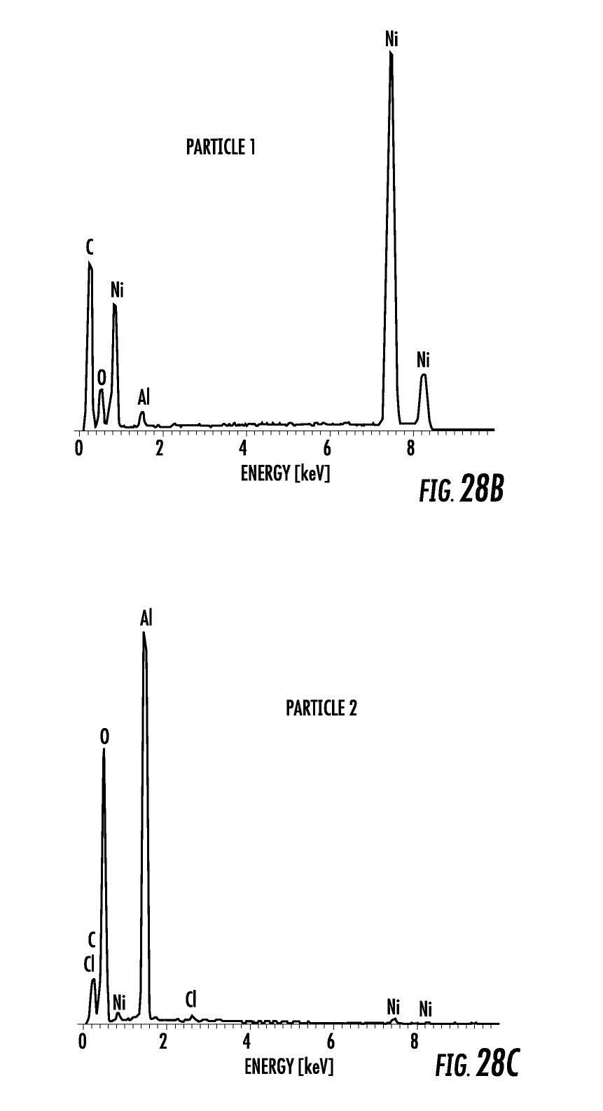

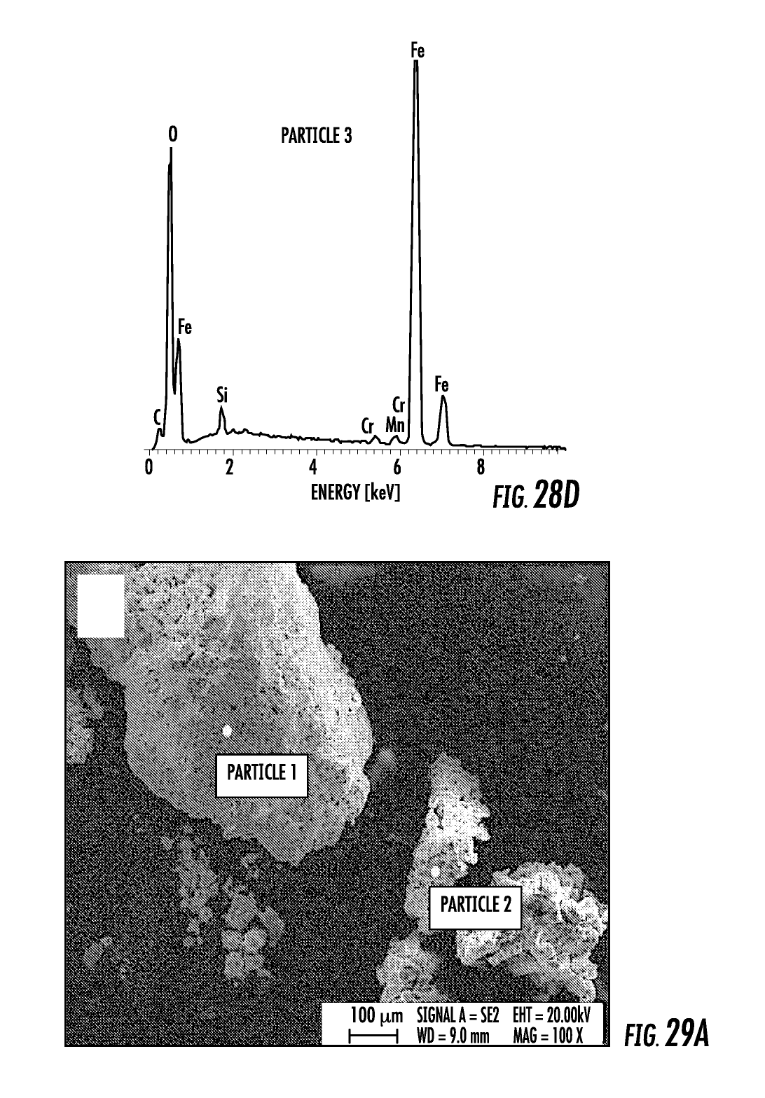

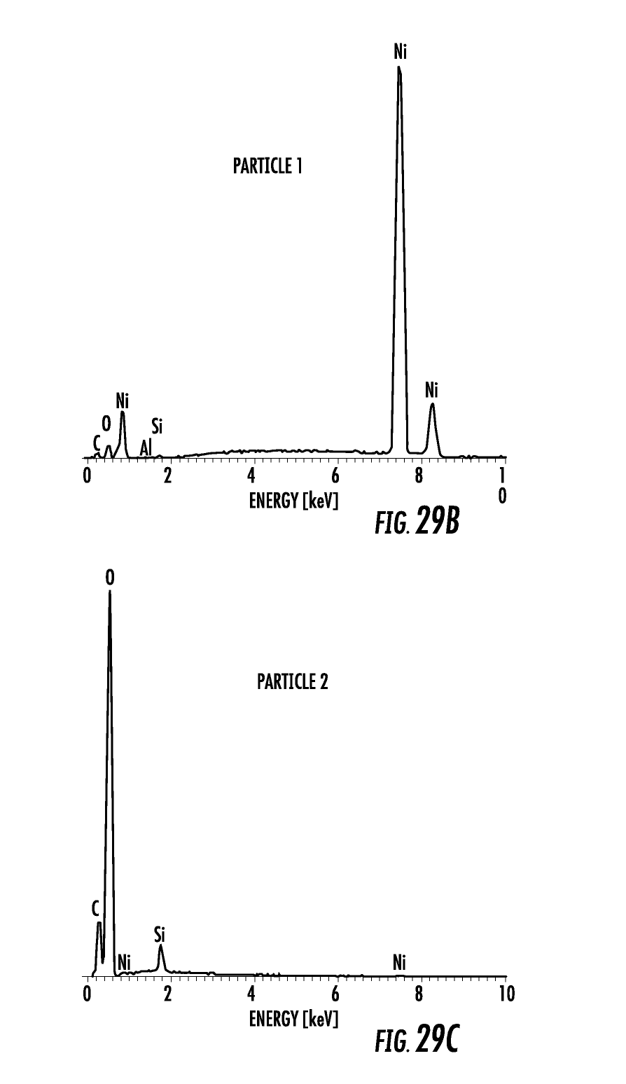

FIGS. 26A-26C and 27A-27B show that there exist different types of particles in the fuel and ash. The SEM images show that all particle types have different surface morphology and the EDS spectra, FIGS. 28A-28D and 29A-29B show that the chemistry also differs between the particles. Thus, it can be expected that the results from the ToF-SIMS measurements can vary depending on which type of particle is analyzed. Note that Li cannot be detected using EDS.

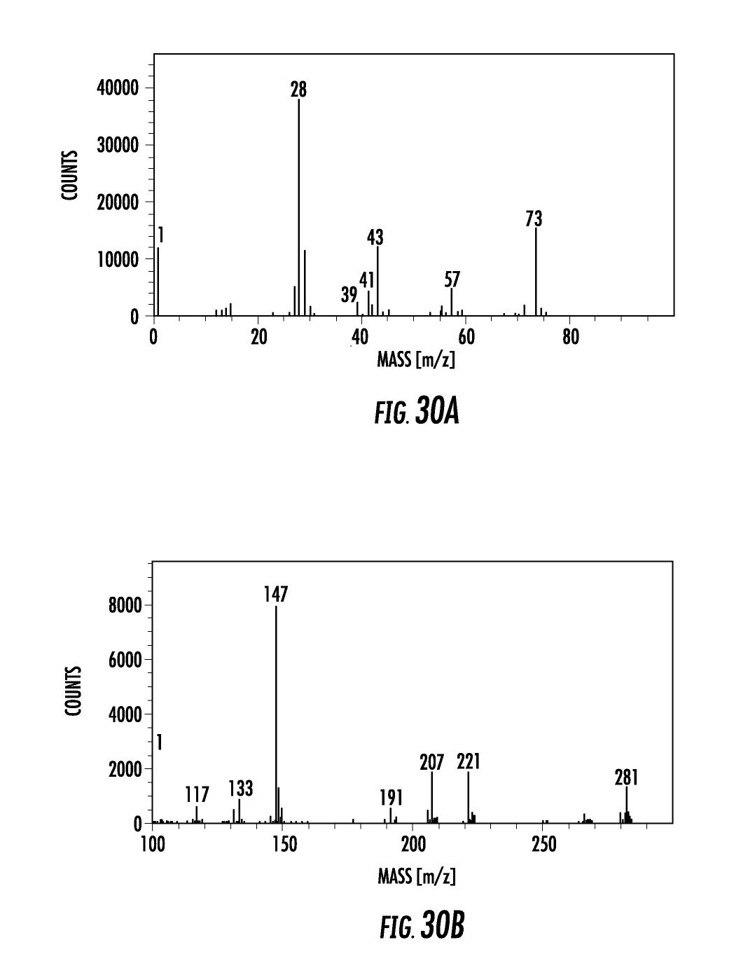

The positive ToF-SIMS spectrum in FIGS. 30A-30B shows the mass spectrum from the surface of the carbon adhesive sticker that the ash is mounted on. The most abundant peaks are characteristic of a dimethyl siloxane type of polymer. Some of the characteristic peaks are due to a linear or cyclic structure:

### Linear Type:

| | | | | | |
|---|---|---|---|---|---|
| 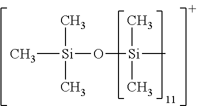 | n m/z | 0 73 | 1 147 | 2 221 | 3 295 |

### Cyclic Type:

| | | | | | |
|---|---|---|---|---|---|
| 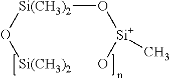 | n m/z | 0 133 | 1 207 | 2 281 | 3 355 |

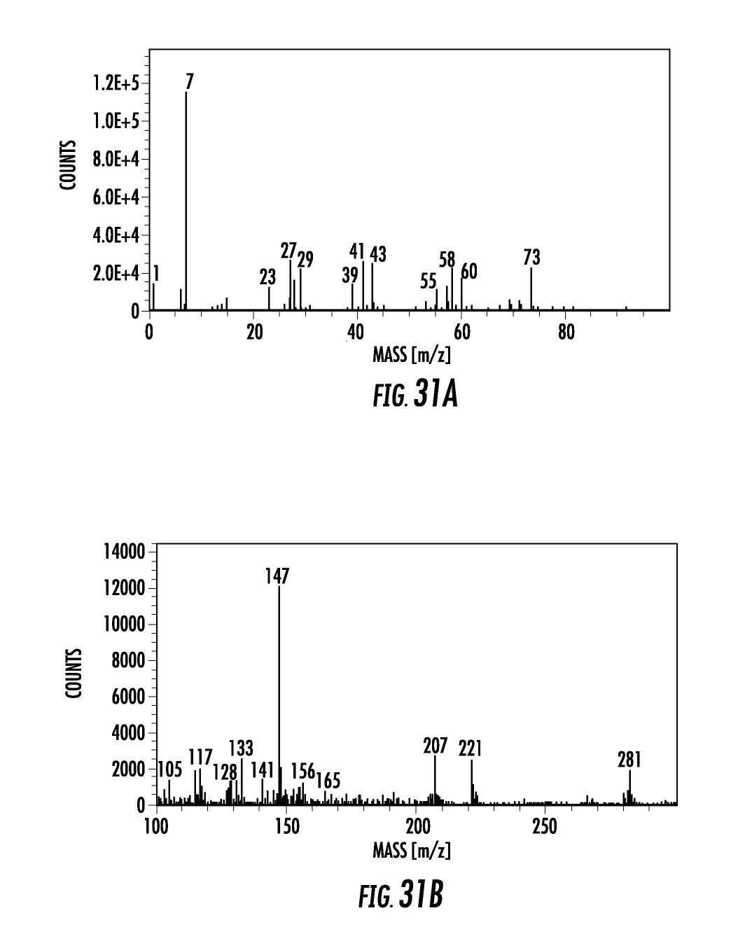

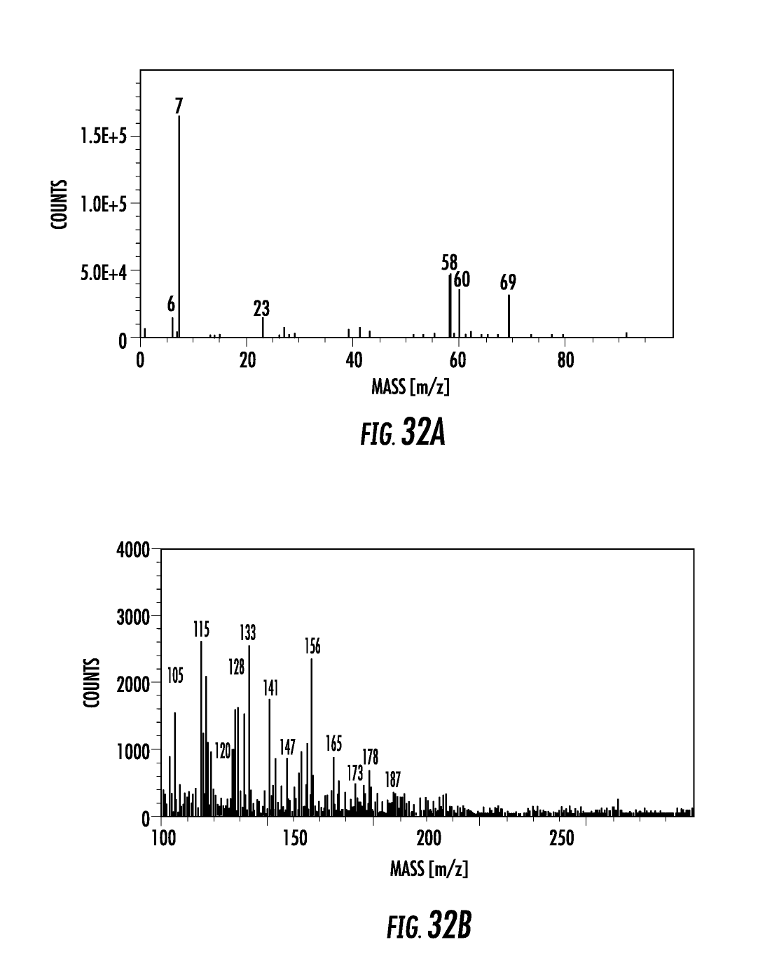

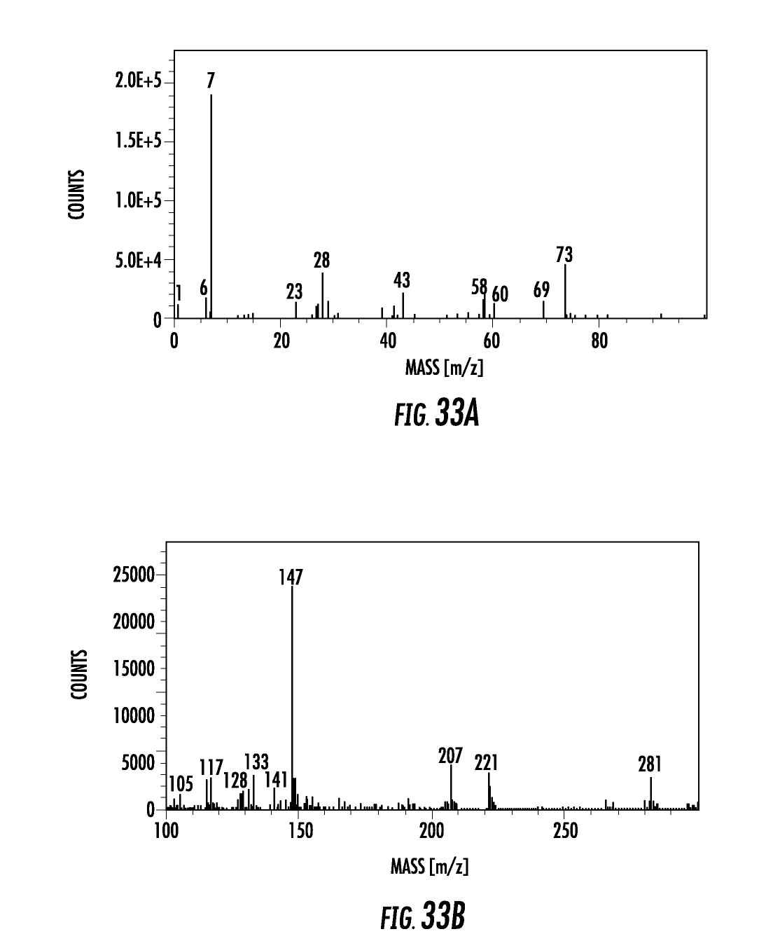

In FIGS. 31A-31B the positive mass spectrum from a reactive material particle is shown. Except from peaks from elements such as Li (m/z=7) and Ni (m/z=58) it can be seen that the characteristic peaks from a siloxane are present in the mass spectra. To remove the siloxane that has diffused over the particle surface, the area being analyzed is sputtered. FIGS. 32A-32B show the positive mass spectrum from a particle surface sputter cleaned for 180 seconds. As can be seen, the characteristic peaks from the siloxane are more or less removed. The presence of a small Si peak, not seen in the figure, is the remains of the siloxane. It should be noted that the Si signal may be due to an element coming from the fuel material itself. To prove that the siloxane is coming from the siloxane in the carbon adhesive sticker the sample were left for 16 hours in the vacuum chamber and analyzed at the same position that previously were sputter cleaned. The positive mass spectrum from this experiment is shown in FIGS. 33A-33B and the presence of the characteristic peaks from a siloxane are apparent, i.e. surface diffusion of the siloxane has occurred. Thus, spectrum presented henceforth is acquired from sputter cleaned areas.

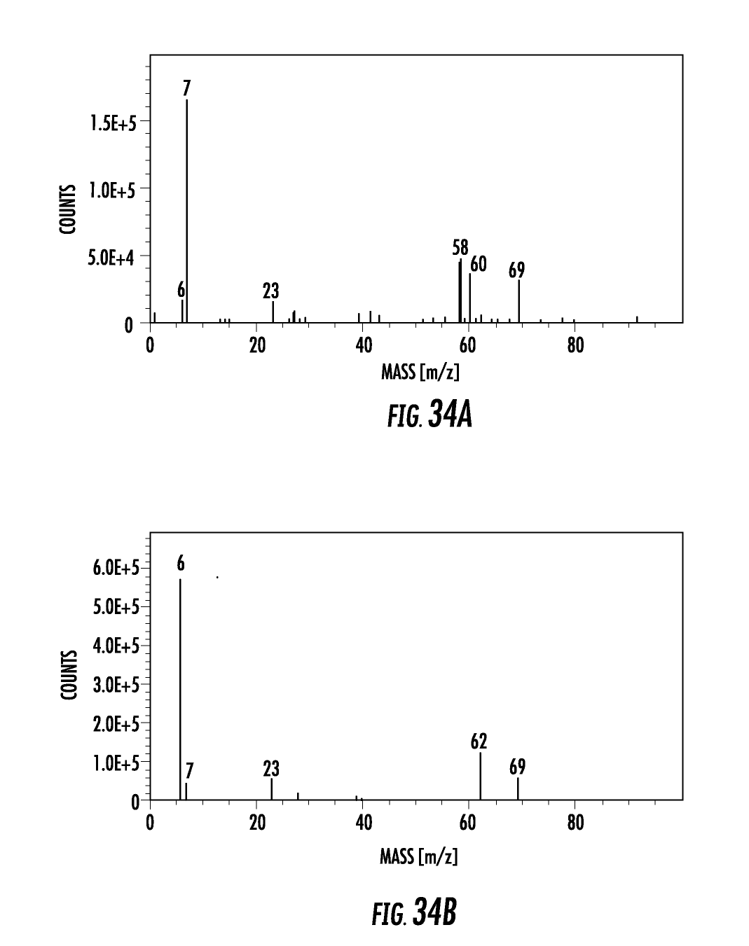

In FIGS. 34A-34B the positive mass spectrum from the fuel and the ash is presented. The main ion peaks are Li⁺ (m/z=6 and 7), Na⁺ (m/z=23), Ni⁺ (m/z=58 and 60 in the fuel and m/z=62 in the ash) and 69⁺ (m/z=69). The Na⁺ ion signal comes from the primary ions. The origin of Na⁺ is either from some contamination, the carbon adhesive sticker, or the material itself. The probability for generating Na⁺ as secondary ions is extremely high and the importance of the signal can be overestimated. In the spectra from the ash, there seems to be a change in abundance of the isotopes for Li and Ni. In the fuel the abundance is close to what is naturally expected, see Table 16. In the ash the abundance of Li and Ni is altered, see Table 16.

TABLE 16
Measured and natural occurring abundances for Li and Ni ions in fuel and
ash, respectively.

| | Fuel | | Ash | | |
|---|---|---|---|---|---|
| | | Measured | | Measured | |
| | Counts in | abundance | Counts in | abundance | Natural |
| Ion | peak | [%] | peak | [%] | abundance [%] |
| ⁶Li⁺ | 15804 | 8.6 | 569302 | 92.1 | 7.5 |
| ⁷Li⁺ | 168919 | 91.4 | 48687 | 7.9 | 92.5 |
| ⁵⁸Ni⁺ | 93392 | 67 | 1128 | 0.8 | 68.1 |
| ⁶⁰Ni⁺ | 36690 | 26.3 | 635 | 0.5 | 26.2 |
| ⁶¹Ni⁺ | 2606 | 1.9 | ~0 | 0 | 1.8 |
| ⁶²Ni⁺ | 5379 | 3.9 | 133272 | 98.7 | 3.6 |
| ⁶⁴Ni⁺ | 1331 | 1 | ~0 | 0 | 0.9 |

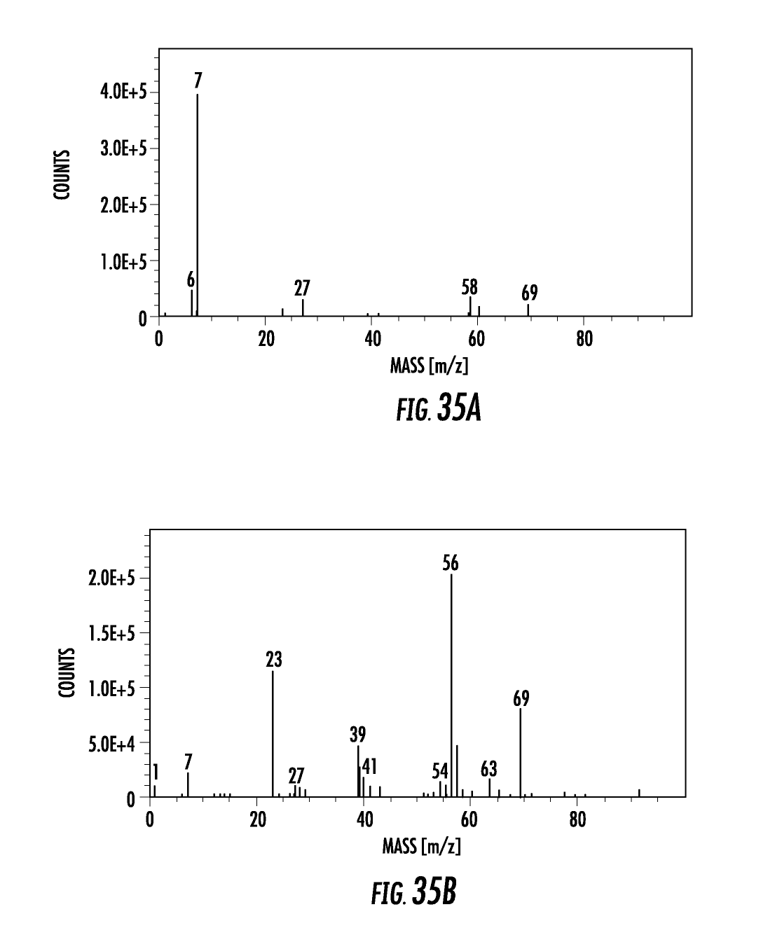

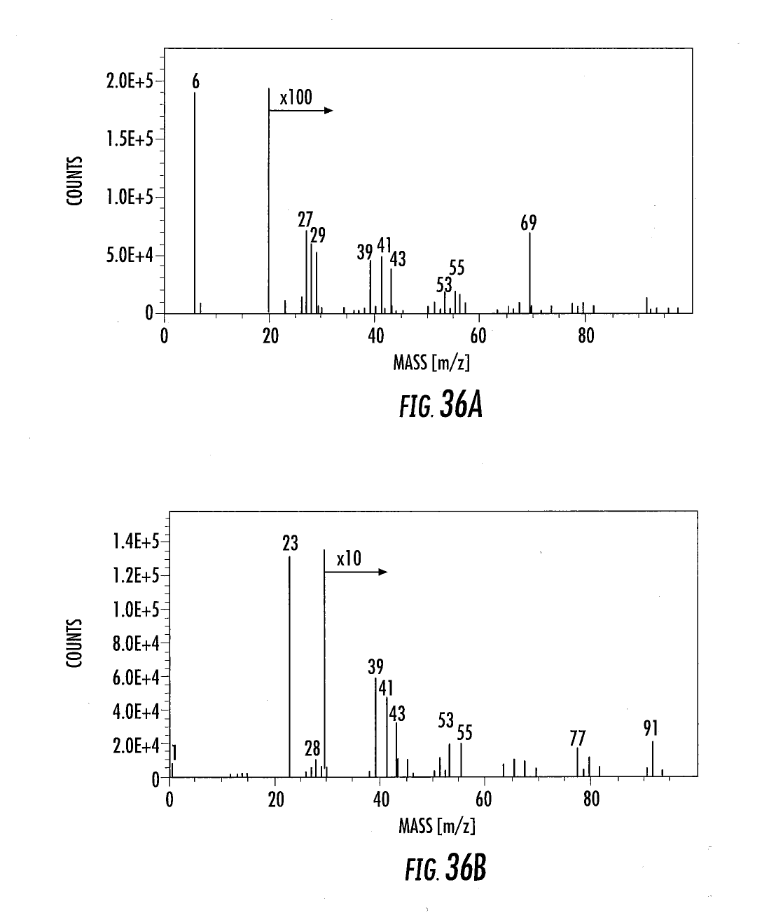

FIGS. 35A-35B and 36A-36B show the positive mass spectra from different types of fuel and ash powder grains, respectively. Thus, the appearance of the ToF-SIMS spectra will differ depending on particle analyzed.

### Conclusions

A conclusion that can be drawn from this SEM/EDS and ToF-SIMS study of samples from a fuel and a reaction product of the fuel, called ash, are:
there are different types of powder particles in both samples.
in the fuel sample, the detected ions have a natural abundance.
In the ash sample, some ions, i.e. Li and Ni have an abundance deviating from the natural abundance.

### Results ICP-MS and ICP-AES

The samples are placed in quartz micro-Kjedahl vessels for dissolution with extra pure sub-boiled nitric acid (3.0 ml). They were heated to 136 degree and after that diluted to 50.0 ml. Further dilution 1000 times was done before the measurement with ICP-MS. The resulting values are corrected with blanks (the pure acid). The isotopic abundances are calculated and presented in Table 17 below. Standards are known reference solutions in order to check the instrument. The natural isotopic abundance is shown in the last line of the table. The difference between the standards and the natural abundance is due to the fact that the signals are not mass biased corrected with isotopic reference standards.

TABLE 17

| mg sample | Sample id | Li 6 | Li 7 | Ni 58 | Ni 60 | Ni 61 | Ni 62 |
|---|---|---|---|---|---|---|---|
| | Standard 2 | 6.0 | 94. | 66.0 | 27.6 | 1.3 | 4.0 |
| | Standard 3 | 6.0 | 94.0 | 66.1 | 27.5 | 1.3 | 4.1 |
| | Standard 4 | 6.0 | 94.0 | 66.0 | 27.5 | 1.2 | 4.1 |
| 2.13 | sample 1 ash | 57.5 | 42.5 | 0.3 | 0.3 | 0.0 | 99.3 |
| 2.13 | Sample 2 fuel | 5.9 | 94.1 | 65.9 | 27.6 | 1.3 | 4.2 |
| | Nat. abundance | 7.6 | 92.4 | 68.1 | 26.2 | 1.1 | 3.6 |

Three different samples were analyzed by inductively coupled plasma atomic emission spectroscopy operated at standard conditions, ICP-AES. The samples are placed in quartz micro-Kjedahl vessels for dissolution with extra pure sub-boiled nitric acid (3.0 ml). Heated to 136 degree and after that diluted to 50.0 ml. The concentrations are calculated against acid matched calibration solutions.

The measured analytes were Ni, Li, and Al. The elements Ni and Al are measured with two independent emission lines to minimize risk for systematic errors. The elements C, H, O, N, He, Ar and F cannot be measured quantitatively by this technique. Sample 1 was ash coming from the reactor. Only a few granules of grey sample were possible to obtain from the ash and they did not look exactly the same. One large and two very small granules were observed. Sample 2 was the fuel used to charge the E-Cat. It is in the form of a very fine powder. Besides the analyzed elements it has been found that the fuel also contains rather high concentrations of C, Ca, Cl, Fe, Mg, Mn and these are not found in the ash.

### Results as Weight Percent of the Samples

| | Ni 231 | | Li 670 | | Al 394 |
|---|---|---|---|---|---|
| | nm % | Ni 232 nm % | nm % | Al 396 nm % | nm % |
| 1 ash 2.13 | 95.9 | 95.6 | 0.03 | 0.00 | 0.05 |
| mg 50 ml | | | | | |
| 2 fuel 2.13 | 55.4 | 55.0 | 1.17 | 4.36 | 4.39 |
| mg 50 ml | | | | | |

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

### REFERENCES

[1] G. Levi et al, Indication of anomalous heat energy production in a reactor device containing hydrogen loaded nickel powder, http://arxiv.org/abs/1.305.3913.
[2] Optris, Basic principles of non-contact temperature measurement, www.optris.com.
[3] R. Morrell, Handbook of properties of technical and engineering ceramics Part 2, 1985, H.M.S.O.
[4] A. Gillespie, S. Rokugawa, A temperature and emissivity separation algorithm for advanced spacebornethermal emission and reflection radiometer (ASTER) images, IEEE Transactions on Geoscience and Remote Sensing, VOL. 36, N. 4, July 1998.
[5] Volker Tank, Method for the contactless radiation measurement of the temperature of an object independent of its emissivity, and device for carrying out this method, EP0129150.
[6] J. M. Coulson and J. F. Richardson, Chemical Engineering, 1999 (sixth edition), Butterworth Heinemann.
[7] E. Hahne, D. Zhu, Natural convection heat transfer on finned tubes in air, Int. J. Heat Mass Transfer, Vol. 37 (59-63), 1994 Elsevier Science Ltd.
[8]A. D. Kraus, A. Aziz, Extended surface heat transfer, 2001, John Wiley & Sons Inc.
[9] T. L. Bergman, A. S. Lavine, Fundamentals of heat and mass transfer, 2011 (seventh edition), John Wiley & Sons Inc.
[10] A. Bejan, A. D. Kraus, Heat Transfer Handbook, 2003, John Wiley & Sons Inc.
[11] A. F. Ghoniem, Needs, resources and climate change: clean and efficient conversion technologies, Progress in Energy and Combustion Science 37 (2011), 15-51, FIG. 38.
[12] http://www.whatisnuclear.com/physics/energy_density_of nuclear.html.
[13]http://en.wikipedia.org/wiki/File:Energy_density.svg.
[14] R. Raiola et al. Enhanced d(d,p)t fusion reaction in metals, Eur. Phys. J. A 27, s01, 79-82 (2006)
[15] LUNA Collaboration, J. Cruz et al, Electron screening in ⁷Li(p, α)α and ⁶Li(p, α) 3He for different environments, Physics Letters B 624 (2005) 181-185.
[16] C. Rolf, Nuclear reactions in stars far below the Coulomb harrier, Progress in Particle and Nuclear Physics 59 (2007) 43-50.
[17] n_TOF Collaboration, M. Barbagallo et al. Measurement of ⁷Be(n, α)⁻¹He and ⁷Be(n,p)⁷Li cross sections for the Cosmological Lithium Problem, CERN-INTC-2014-049 / INTC-P-417, May 6, 2014.

That which is claimed is:

1. A reactor device comprising:
a reaction chamber;
one or more thermal units in thermal communication with the reaction chamber configured to transfer thermal energy to the reaction chamber; and
a refractory layer between the reaction chamber and the one or more thermal units.

2. The reactor device of claim 1, wherein the refractory layer comprises at least one recess configured to receive the one or more thermal units therein.

3. The reactor device of claim 2, wherein the one or more thermal units comprise one or more resistive wires.

4. The reactor device of claim 3, wherein the at least one recess comprises a spiral groove and the one or more resistive wires are helically-disposed in the groove.

5. The reactor device of claim 4, wherein the one or more resistive wires comprises at least three wires for carrying an alternating-current or a direct-current electric power.

6. The reactor device of claim 5, wherein the refractory layer comprises a ribbed or finned surface that increases heat dissipation away from the reaction chamber.

7. The reactor device of claim 1, further comprising sealing members that seal the reaction chamber.

8. The reactor device of claim 1, wherein the reaction chamber is open such that it does not maintain a pressurized seal.

9. The reactor device of claim 1, wherein the reaction chamber comprises a longitudinally extending cylinder.

10. A reactor system comprising:
a reactor device comprising:
a reaction chamber;
one or more thermal units in thermal communication with the reaction chamber configured to transfer thermal energy to the reaction chamber;
a refractory layer between the reaction chamber and the one or more thermal units.
a controller configured to control a thermal output of the one or more thermal units.

11. The reactor system of claim 10, further comprising a temperature sensor configured to sense a temperature in at least a portion of the reaction chamber.

12. The reactor system of claim 11, wherein the controller is configured to control the thermal output of the one or more thermal units responsive to a temperature sensed by the temperature sensor.

13. The reactor system of claim 10, wherein the refractory layer comprises at least one recess configured to receive the one or more thermal units therein.

14. The reactor system of claim 13, wherein the one or more thermal units comprise one or more resistive wires.

15. The reactor system of claim 14, wherein the at least one recess comprises a spiral groove and the one or more resistive wires are helically-disposed in the groove.

16. The reactor system of claim 15, wherein the one or more resistive wires comprises at least three wires carrying a three-phase alternating-current electric power.

17. The reactor system of claim 16, wherein the refractory layer comprises a ribbed or finned surface that increases heat dissipation away from the reaction chamber.

18. The reactor system of claim 10, further comprising sealing members that seal the reaction chamber.

19. The reactor system of claim 10, wherein the reaction chamber is open such that it does not maintain a pressurized seal.

20. The reactor system of claim 10, wherein the reaction chamber comprises a longitudinally extending space wherein the space has a closed geometric cross-section in at least one portion of the reaction chamber.
